(19) United States
(12) Patent Application Publication
(10) Pub. No.: US 2024/0337814 A1
(43) Pub. Date: Oct. 10, 2024

(54) OPTICAL IMAGING SYSTEM

(71) Applicants: Samsung Electro-Mechanics Co., Ltd., Suwon-si (KR); Kumoh National Institute of Technology Industry-Academic Cooperation Foundation, Gumi-si (KR)

(72) Inventors: Tae Yeon LIM, Suwon-si (KR); Jae Myung RYU, Gumi-si (KR); Yong Joo JO, Suwon-si (KR); Phil Ho JUNG, Suwon-si (KR)

(73) Assignees: Samsung Electro-Mechanics Co., Ltd., Suwon-si (KR); Kumoh National Institute of Technology Industry-Academic Cooperation Foundation, Gumi-si (KR)

(21) Appl. No.: 18/627,741

(22) Filed: Apr. 5, 2024

(30) Foreign Application Priority Data
Apr. 5, 2023 (KR) 10-2023-0044659

(51) Int. Cl. G02B 9/34

(52) U.S. Cl. CPC G02B 9/34

(57) ABSTRACT

An optical imaging system includes a first lens group, a second lens group, a third lens group, and a fourth lens group sequentially disposed in ascending numerical order along an optical axis of the optical imaging system away from an object side of the optical imaging system toward an imaging plane of the optical imaging system, at least one lens group among the first to fourth lens groups being configured to be movable along the optical axis; and a reflective member disposed on an object side of the first lens group and including a reflective surface configured to change an optical path, wherein the first lens group has a positive refractive power, and 0.45≤fG1/L≤0.8 is satisfied, where fG1 is a focal length of the first lens group, and L is a distance from an object-side surface of the reflective member to the imaging plane.

### CROSS-REFERENCE TO RELATED APPLICATIONS

This application claims the benefit under 35 USC 119 (a) of Korean Patent Application No. 10-2023-0044659 filed on Apr. 5, 2023, in the Korean Intellectual Property Office, the entire disclosure of which is incorporated herein by reference for all purposes.

### BACKGROUND

### 1. Field

The present disclosure relates to an optical imaging system.

### 2. Description of Related Art

A camera has become a basic feature in portable electronic devices, including smartphones.

In order to simulate an optical zoom effect, a method of providing a plurality of camera modules having different focal lengths in portable electronic devices has been proposed.

However, such a method not only requires a plurality of camera modules to simulate the optical zoom effect, but the plurality of camera modules also have different fields of view, so that when an image is captured at a medium magnification, image processing through software rather than optical zoom is needed, resulting in a reduction in image quality.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group, a second lens group, a third lens group, and a fourth lens group sequentially disposed in ascending numerical order along an optical axis of the optical imaging system away from an object side of the optical imaging system toward an imaging plane of the optical imaging system, at least one lens group among the first to fourth lens groups being configured to be movable along the optical axis; and a reflective member disposed on an object side of the first lens group and including a reflective surface configured to change an optical path of the optical imaging system, wherein the first lens group has a positive refractive power, and 0.45≤fG1/L≤0.8 is satisfied, where fG1 is a focal length of the first lens group, and L is a distance on the optical axis from an object-side surface of the reflective member to the imaging plane.

The first lens group may include a first lens and a second lens sequentially disposed in ascending numerical order along the optical axis from an object side of the first lens group toward an image side of the first lens group, one of the first lens and the second lens may have a positive focal length and an Abbe number of 50 or more, and another one of the first lens and the second lens may have a negative focal length and an Abbe number of 30 or less.

(n1+n2)/2>1.7 may be satisfied, wherein n1 is a refractive index of the first lens and n2 is a refractive index of the second lens.

An image-side surface of the first lens and an object-side surface of the second lens may be bonded to each other, and the first lens and the second lens may each made of a respective glass material.

The second lens group may have a negative refractive power, may include at least two lenses, and may be configured to move along the optical axis away from the object side of the optical imaging system toward the image side of the optical imaging system to narrow a field of view of the optical imaging system.

0.4≤LG3/L≤0.7 may be satisfied, where LG3 is a distance on the optical axis from the object-side surface of the reflective member to an object-side surface of a frontmost lens of the third lens group.

0.08≤dG2/L≤0.7 may be satisfied, where dG2 is a distance along the optical axis that the second lens group moves from a wide-angle mode of the optical imaging system to a telephoto mode of the optical imaging system.

A frontmost lens of the second lens group may have a largest effective radius among all lenses in the second to fourth lens groups.

The first lens group and the third lens group may be fixedly disposed, and the fourth lens group may be configured to move along the optical axis to correct a focal position of the optical imaging system as the second lens group is moved along the optical axis.

0.4≤BFLw/BFLt≤2.8 may be satisfied, where BFLw is a distance on the optical axis from an image-side surface of a last lens of the fourth lens group to the imaging plane in a wide-angle mode of the optical imaging system, and BFLt is a distance on the optical axis from the image-side surface of the last lens of the fourth lens group to the imaging plane in a telephoto mode of the optical imaging system.

The third lens group and the fourth lens group may each have a positive refractive power.

The third lens group may include a stop and a plurality of lenses sequentially disposed along the optical axis away from an object side of the third lens group toward an image side of the third lens group, and a lens disposed closest to the stop among the plurality of lenses of the third lens group may have a positive refractive power.

1.2≤Dmax/SD≤1.55 may be satisfied, where Dmax is an effective radius of a lens having a largest effective radius among all lenses in the second to fourth lens groups, and SD is a radius of the stop.

The third lens group may include two lenses sequentially disposed along the optical axis away from the object side of the third lens group toward the image side of the third lens group, one of the two lenses of the third lens group may have a positive focal length and an Abbe number greater than 50, and another one of the two lenses of the third lens group may have a negative focal length and an Abbe number less than 30.

The fourth lens group may include at least one lens having an Abbe number greater than 50.

1.2≤EPDt/EPDw≤4.4 may be satisfied, where EPDw is an entrance pupil diameter of the optical imaging system in a wide-angle mode of the optical imaging system, and EPDt is an entrance pupil diameter of the optical imaging system in a telephoto mode of the optical imaging system.

In another general aspect, an optical imaging system includes a first lens group, a second lens group, a third lens group, and a fourth lens group sequentially disposed in ascending numerical order along an optical axis of the optical imaging system away from an object side of the optical imaging system toward an imaging plane of the optical imaging system, at least one lens group among the first to fourth lens groups being configured to be movable along the optical axis; and a reflective member disposed on an object side of the first lens group and including a reflective surface configured to change an optical path of the optical imaging system, wherein the first lens group has a positive refractive power, and 0.4≤LG3/L≤ 0.7 is satisfied, where LG3 is a distance on the optical axis from an object-side surface of the reflective member to an object-side surface of the third lens group.

The first lens group may include two lenses, the second lens group may have a negative refractive power and may include two or three lenses, the third lens group may have a positive refractive power and may include a stop and two lenses, and the fourth lens group may have a positive refractive power and may include one or two lenses.

The second lens group may be configured to be movable along the optical axis to change a focal length of the optical imaging system between a wide-angle mode and a telephoto mode, and 0.4≤BFLw/BFLt≤2.8 may be satisfied, where BFLw is a distance from an image-side surface of a last lens of the fourth lens group to the imaging plane in the wide-angle mode, and BFLt is a distance from the image-side surface of the last lens of the fourth lens group to the imaging plane in the telephoto mode.

The second lens group may be configured to be movable along the optical axis to change a focal length of the optical imaging system between a wide-angle mode and a telephoto mode, and 1.2≤EPDt/EPDw≤4.4 may be satisfied, where EPDw is an entrance pupil diameter of the optical imaging system in the wide-angle mode, and EPDt is an entrance pupil diameter of the optical imaging system in the telephoto mode.

In another general aspect, an optical imaging system includes a first lens group, a second lens group, a third lens group, and a fourth lens group sequentially disposed in ascending numerical order along an optical axis of the optical imaging system away from an object side of the optical imaging system toward an imaging plane of the optical imaging system, the second lens group being configured to be movable along the optical axis to change a focal length of the optical imaging system between a wide-angle mode and a telephoto mode; and a reflective member disposed on an object side of the first lens group and including a reflective surface configured to change an optical path of the optical imaging system, wherein the first lens group has a positive refractive power, and 0.08≤dG2/L≤0.7 is satisfied, where dG2 is a distance along the optical axis that the second lens group moves between the wide-angle mode and the telephoto mode.

The first lens group may include two lenses, the second lens group may have a negative refractive power and may include two or three lenses, the third lens group may have a positive refractive power and may include a stop and two lenses, and the fourth lens group may have a positive refractive power and may include one or two lenses.

0.4≤BFLw/BFLt≤2.8 may be satisfied, where BFLw is a distance from an image-side surface of a last lens of the fourth lens group to the imaging plane in the wide-angle mode, and BFLt is a distance from the image-side surface of the last lens of the fourth lens group to the imaging plane in the telephoto mode.

1.2≤EPDt/EPDw≤4.4 may be satisfied, where EPDw is an entrance pupil diameter of the optical imaging system in the wide-angle mode, and EPDt is an entrance pupil diameter of the optical imaging system in the telephoto mode.

Other features and aspects will be apparent from the following detailed description, the drawings, and the claims.

### BRIEF DESCRIPTION OF DRAWINGS

FIG. 1 is a diagram illustrating a wide-angle mode of an optical imaging system according to a first embodiment of the present disclosure.

FIG. 2 is a diagram illustrating a normal mode of the optical imaging system of FIG. 1.

FIG. 3 is a diagram illustrating a telephoto mode of the optical imaging system of FIG. 1.

FIG. 4 is a diagram illustrating a wide-angle mode of the optical imaging system according to a second embodiment of the present disclosure.

FIG. 5 is a diagram illustrating a normal mode of the optical imaging system of FIG. 4.

FIG. 6 is a diagram illustrating a telephoto mode of the optical imaging system of FIG. 4.

FIG. 7 is a diagram illustrating a wide-angle mode of an optical imaging system according to a third embodiment of the present disclosure.

FIG. 8 is a diagram illustrating a normal mode of the optical imaging system of FIG. 7.

FIG. 9 is a diagram illustrating a telephoto mode of the optical imaging system of FIG. 7.

FIG. 10 is a diagram illustrating a wide-angle mode of an optical imaging system according to a fourth embodiment of the present disclosure.

FIG. 11 is a diagram illustrating a normal mode of the optical imaging system of FIG. 10.

FIG. 12 is a diagram illustrating a telephoto mode of the optical imaging system of FIG. 10.

FIG. 13 is a diagram illustrating a wide-angle mode of an optical imaging system according to a fifth embodiment of the present disclosure.

FIG. 14 is a diagram illustrating a normal mode of the optical imaging system of FIG. 13.

FIG. 15 is a diagram illustrating a telephoto mode of the optical imaging system of FIG. 13.

FIG. 16 is a diagram illustrating a wide-angle mode of an optical imaging system according to a sixth embodiment of the present disclosure.

FIG. 17 is a diagram illustrating a normal mode of the optical imaging system of FIG. 16.

FIG. 18 is a diagram illustrating a telephoto mode of the optical imaging system of FIG. 16.

FIG. 19 is a diagram illustrating a wide-angle mode of an optical imaging system according to a seventh embodiment of the present disclosure.

FIG. 20 is a diagram illustrating a normal mode of the optical imaging system of FIG. 19.

FIG. 21 is a diagram illustrating a telephoto mode of the optical imaging system of FIG. 19.

FIG. 22 is a diagram illustrating a wide-angle mode of an optical imaging system according to an eighth embodiment of the present disclosure.

FIG. 23 is a diagram illustrating a normal mode of the optical imaging system of FIG. 22.

FIG. 24 is a diagram illustrating a telephoto mode of the optical imaging system of FIG. 22.

FIG. 25 is a diagram illustrating a wide-angle mode of an optical imaging system according to a ninth embodiment of the present disclosure.

FIG. 26 is a diagram illustrating a normal mode of the optical imaging system of FIG. 25.

FIG. 27 is a diagram illustrating a telephoto mode of the optical imaging system of FIG. 25.

FIG. 28 is a diagram illustrating a wide-angle mode of an optical imaging system according to a tenth embodiment of the present disclosure.

FIG. 29 is a diagram illustrating a normal mode of the optical imaging system of FIG. 28.

FIG. 30 is a diagram illustrating a telephoto mode of the optical imaging system of FIG. 28.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the drawings, the thicknesses, sizes, and shapes of the lenses may be exaggerated for illustrative purposes. In particular, shapes of spherical or aspherical surfaces illustrated in the drawings are only presented as examples, and are not limited thereto.

An optical imaging system according to an embodiment of the present disclosure may be mounted in a portable electronic device. For example, the optical imaging system may be a component of a camera module mounted in the portable electronic device. The portable electronic device may be a portable electronic device such as a mobile communication terminal, a smartphone, or a tablet PC.

In an optical imaging system according to an embodiment of the present disclosure, a first lens (or a frontmost lens) may refer to a lens closest to an object side of the optical imaging system, and a last lens (or a rearmost leans) may refer to a lens closest to an imaging plane (or an image sensor) of the optical imaging system.

In addition, in each lens, a first surface (or an object-side surface) may refer to a surface closest to the object side of the optical imaging system, and a second surface (or an image-side surface) may refer to a surface closest to the image side of the optical imaging system.

In addition, in the present specification, all numerical values of radiuses of curvature, thicknesses, distances, focal lengths and other dimensions may be indicated in millimeters (mm), and fields of view (FOV) may be indicated in degrees (*).

In addition, in the description of a shape of each lens, a statement that a surface of a lens is convex may mean that the surface is convex in a paraxial region of the surface, and a statement that a surface of a lens is concave may mean that the surface is concave in a paraxial region of the surface.

Accordingly, even if a surface of a lens is described as having a convex shape, an edge portion of the surface may have a concave shape. Similarly, even if a surface of a lens is described as having a concave shape, an edge portion of the surface may have a convex shape.

A paraxial region of a lens surface is a central portion of the lens surface surrounding the optical axis of the lens surface in which light rays incident to the lens surface make a small angle θ to the optical axis, and the approximations sin θ≈θ, tan θ≈θ, and cos θ≈1 are valid.

An imaging plane may refer to a virtual surface on which a focal point is formed by the optical imaging system. Alternatively, the imaging plane may refer to one surface of an image sensor receiving light through the optical imaging system.

The optical imaging system according to an embodiment of the present disclosure may include a plurality of lens groups. As an example, the optical imaging system may include a first lens group, a second lens group, a third lens group, and a fourth lens group.

The first to fourth lens groups may collectively include a plurality of lenses. As an example, the optical imaging system may include at least seven lenses.

In an embodiment, the optical imaging system may include a first lens, a second lens, a third lens, a fourth lens, a fifth lens, a sixth lens, a seventh lens, an eighth lens, a ninth lens, and a tenth lens sequentially disposed in ascending numerical order along an optical axis of the optical imaging system from an object side of the optical imaging system toward an image side of the optical imaging system.

In another embodiment, the optical imaging system may include a first lens, a second lens, a third lens, a fourth lens, a fifth lens, a sixth lens, and a seventh lens sequentially disposed in ascending numerical order along an optical axis of the optical imaging system from an object side of the optical imaging system toward an image side of the optical imaging system.

The optical imaging system according to an embodiment of the present disclosure may further include a reflective member having a reflective surface for changing an optical path of light. As an example, the reflective member may be a mirror or a prism.

The optical path of light may be bent by the reflective member, thereby forming a long optical path in a relatively narrow space. The reflective member may be disposed in front of the first lens group.

Accordingly, the optical imaging system may reduced in size while having a long focal length.

In addition, the optical imaging system may further include an image sensor for converting an image of a subject incident on the image sensor through the optical imaging system into an electrical signal.

In addition, the optical imaging system may further include an infrared blocking filter (hereinafter referred to as a filter) for blocking infrared rays. The filter may be disposed between a rearmost lens of the optical imaging sensor and the image sensor.

In addition, the optical imaging system may further include a stop disposed between the second lens group and the third lens group. In an embodiment, the stop may be disposed between the fifth lens and the sixth lens. In another embodiment, the stop may be disposed between the sixth lens and the seventh lens. In another embodiment, the stop may be disposed between the fourth lens and the fifth lens.

In an embodiment, the first lens group may include a first lens and a second lens, the second lens group may include a third lens, a fourth lens, and a fifth lens, the third lens group may include a sixth lens and a seventh lens, and the fourth lens group may include an eighth lens, a ninth lens, and a tenth lens. The third lens group may further include a stop disposed in front of the sixth lens. The stop may also be disposed between the sixth lens and the seventh lens.

In another embodiment, the first lens group may include a first lens and a second lens, the second lens group may include a third lens and a fourth lens, the third lens group may include a fifth lens and a sixth lens, and the fourth lens group may include a seventh lens. The third lens group may further include a stop disposed in front of the fifth lens.

In an embodiment, some lenses, among the plurality of lenses, may be bonded together to form a bonded lens. In an embodiment, the first lens and the second lens may be bonded together to form a bonded lens. In addition, an image-side surface of the second lens may be flat.

Alternatively, the image-side surface of the second lens may be convex. In this case, an absolute value of a radius of curvature of the image-side surface of the second lens may be a highest value among absolute values of radiuses of curvature of all of the surfaces of all the lenses of the optical imaging system.

At least one lens group among the first to fourth lens groups may be moved to change a total focal length of the optical imaging system.

For example, a distance between the first lens group and the second lens group may vary. As an example, the first lens group may be fixedly disposed, and the second lens group may be disposed to be movable in an optical axis direction. As the second lens group is moved away from the object side of the optical imaging system toward the image side of the optical imaging system, the total focal length of the optical imaging system may change from a wide-angle mode to a normal mode to a telephoto mode.

The first lens group may be positioned at the front of the optical imaging system, thereby easily implementing water resistance and dust resistance when the first lens group is fixed.

The first lens group may generally have a positive refractive power, and may include at least one lens having a meniscus shape that is convex toward the object side.

In an embodiment, the first lens group may include two lenses (for example, a first lens and a second lens).

The two lenses may be bonded to each other. For example, an image-side surface of the first lens and an object-side surface of the second lens may be bonded to each other.

The first lens may be a meniscus lens having a surface convex toward the object side. In addition, the second lens may have a convex object-side surface and a flat image-side surface. Alternatively, the second lens may have a convex object-side surface and a convex image-side surface.

The first lens and the second lens may have refractive powers having opposite signs, and a combined focal length of the first lens and the second lens may have a positive value.

In addition, the first lens and the second lens may be made of materials having different optical properties. For example, the first lens may be made of a material having a low dispersion coefficient, and the second lens may be made of a material having a high dispersion coefficient, thereby improving chromatic aberration correction capability. A dispersion coefficient may refer to an Abbe Number.

In an embodiment, one of the first lens and the second lens may have an Abbe number of 50 or more, and the other one may have an Abbe number of 40 or less.

In an embodiment, a lens having a positive refractive power among the first lens and the second lens may have an Abbe number of 50 or more, and a lens having a negative refractive power among the first lens and the second lens may have an Abbe number of 40 or less.

In an embodiment, an average value of a refractive index n1 of the first lens and a refractive index n2 of the second lens may be greater than 1.7, i.e., (n1+n2)/2>1.7.

The first lens and the second lens may be made of a glass material, and object-side surfaces and image-side surfaces of the first lens and the second lens may be spherical surfaces.

The second lens group may include a plurality of lenses, and may generally have a negative refractive power.

In an embodiment, the second lens group may include a third lens, a fourth lens, and a fifth lens. The third lens may have a negative refractive power, and may be a meniscus lens having a surface convex toward the object side. The fourth lens may have a negative refractive power, and may be a biconcave lens or a meniscus lens having a surface convex toward the object side. The fifth lens may have a positive refractive power, and may be a meniscus lens having a surface convex toward the object side.

In an embodiment, the second lens group may include a third lens and a fourth lens. One lens among the third and fourth lenses may be a biconcave lens.

For example, the third lens may have a negative refractive power, and may be a biconcave lens. The fourth lens may have a positive refractive power, and may be a meniscus lens having a surface convex toward the object side.

A first lens (for example, a third lens) among lenses included in the second lens group may be a lens having a largest effective radius in the second to fourth lens groups.

All lenses included in the second lens group may be made of a plastic material. As another example, one lens among the lenses included in the second lens group may be made of a glass material, and the remaining lenses may be made of a plastic material.

The third lens group may include a stop and a plurality of lenses, and may generally have a positive refractive power.

Among a plurality of lenses included in the third lens group, a lens disposed to be closest to the stop (for example, a lens positioned immediately behind the stop) may have a positive refractive power.

A combined focal length of the first lens group and the second lens group may have a negative value. That is, light, passing through the first and second lens groups, may be emitted, and thus a lens disposed to be closest to the stop among the lenses included in the third lens group may have a positive refractive power, thereby reducing a diameter of each of lenses disposed therebehind.

In addition, the lens disposed to be closest to the stop (for example, the lens positioned immediately behind the stop) may have an aspherical surface.

The third lens group may include at least two lenses made of materials having different optical properties. For example, the third lens group may include a lens having an Abbe number greater than 50 and a lens having an Abbe number lower than 30.

A lens having an Abbe number greater than 50 may be disposed to be closer to the second lens group than a lens having an Abbe number lower than 30. In addition, a lens having an Abbe number greater than 50 may have a positive refractive power, and a lens having an Abbe number lower than 30 may have a negative refractive power.

In an embodiment, the third lens group may include a stop, a sixth lens, and a seventh lens.

The sixth lens may be a biconvex lens, and may have a positive refractive power. The seventh lens may be a meniscus lens having a surface convex toward the object, and may have a negative refractive power.

In another embodiment, the third lens group may include a stop, a fifth lens, and a sixth lens.

The fifth lens may be a biconvex lens, and may have a positive refractive power. The sixth lens may be a meniscus lens having a surface convex toward the object side, and may have a negative refractive power.

When the second lens group is moved to change the total focal length of the optical imaging system, the third lens group may be fixedly disposed so as not to move.

All lenses included in the third lens group may be made of a plastic material.

The fourth lens group may include at least one lens, and may generally have a positive refractive power.

The fourth lens group may include at least one lens having an Abbe number greater than 50.

In an embodiment, the fourth lens group may include an eighth lens, a ninth lens, and a tenth lens.

One lens among the eighth to tenth lenses may be a biconcave lens.

For example, the eighth lens may be a biconvex lens, and may have a positive refractive power. The ninth lens may be a biconcave lens, and may have a negative refractive power. The tenth lens may have a surface convex toward the image side, and may have a positive refractive power.

In another embodiment, the fourth lens group may include a seventh lens, and the seventh lens may be a biconvex lens, and may have a positive refractive power.

All lenses included in the fourth lens group may be made of a plastic material.

At least one lens group among the first to fourth lens groups may be moved to correct a focal position according to a change in the total focal length of the optical imaging system.

For example, the fourth lens group may be disposed to be movable in the optical axis direction. As the fourth lens group is moved, a distance between the third lens group and the fourth lens group and a distance between the fourth lens group and the image sensor may vary.

For example, when the total focal length of the optical imaging system is changed from a wide-angle mode to a telephoto mode, the fourth lens group may be moved away from the image side toward the object side, or may be moved away from the object side toward the image side, to correct the focal position.

The second lens group may be moved along the optical axis to change the total focal length of the optical imaging system (i.e., to perform an optical zoom function), and the fourth lens group may be moved along the optical axis to correct the focal position as the total focal length of the optical imaging system is changed.

Accordingly, the optical imaging system according to an embodiment of the present disclosure may have an optical zoom function.

The optical imaging system according to an embodiment of the present disclosure may have characteristics of a telephoto lens having a relatively narrow field of view and a long focal length.

The optical imaging system according to an embodiment of the present disclosure may further include a reflective member having a reflective surface for changing an optical path. As an example, the reflective member may be a mirror or a prism.

The optical path may be bent by the reflective member, thereby forming a long optical path in a relatively narrow space.

The reflective member may be disposed in front of the first lens group. The reflective member may configured to rotate about two axes to compensate for shaking when an image is captured.

That is, when shaking occurs due to factors such as a user's hand tremor or the other factors when capturing an image or shooting a video, shaking may be compensated for by rotating the reflective member about either one or both of the two axes in response to the shaking.

The reflective member may be relatively light in weight compared to the optical imaging system, so shaking may be easily compensated for with a smaller driving force.

Some lenses among the plurality of lenses may have aspheric surfaces.

In an embodiment, object-side surfaces and image-side surfaces of lenses other than the first lens, the second lens, and the fifth lens may be aspherical surfaces.

In another embodiment, object-side surfaces and image-side surfaces of lenses other than the first lens and the second lens may be aspherical surfaces.

An aspherical surface of a lens may be represented by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} … \qquad ( 1 )$$

In Equation 1, c is a curvature of the lens and is equal to a reciprocal of a radius of curvature of the lens surface at an optical axis of the lens surface, K is a conic constant, and Y is a distance from any point on the aspherical surface of the lens to the optical axis. In addition, constants A to D are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

The optical imaging system according to an embodiment of the present disclosure may satisfy any one or any combination of any two or more of the following conditions.

$$0.45 \leq fG 1 / L \leq 0.8 \qquad ( 1 )$$

$$0.4 \leq LG 3 / L \leq 0.7 \qquad ( 2 )$$

$$0.08 \leq dG 2 / L \leq 0.7 \qquad ( 3 )$$

$$1.2 \leq D max / SD \leq 1.55 \qquad ( 4 )$$

$$0.4 \leq BFLw / BFLt \leq 2.8 \qquad ( 5 )$$

$$1.2 \leq EPDt / EPDw \leq 4.4 \qquad ( 6 )$$

$$( n 1 + n 2 ) / 2 > 1.7 \qquad ( 7 )$$

In an embodiment, the optical imaging system may satisfy the condition 0.45≤fG1/L≤0.8, where fG1 is a focal length of the first lens group, and L is a distance on the optical axis from a first surface of the reflective member to an imaging plane.

The optical imaging system may include a reflective member, and an optical path of light incident on the reflective member may be changed by 90°, so that the light may incident on a plurality of lenses. Accordingly, an optical axis of the plurality of lenses may be disposed to be perpendicular to a thickness direction of a portable electronic device, so that the number of lenses may not affect a thickness of the portable electronic device. However, in this case, a diameter of each of the plurality of lenses may affect the thickness of the portable electronic device.

Accordingly, the optical imaging system may satisfy the condition 0.45≤fG1/L≤0.8, thereby reducing the diameter of each of the plurality of lenses while securing an appropriate level of resolution. For example, when a lower limit of the condition 0.45≤fG1/L≤0.8 is exceeded, a focal length of the first lens group may be excessively reduced, resulting in a rapid increase in aberration. When an upper limit of the condition 0.45≤fG1/L≤0.8 is exceeded, the focal length of the first lens group may be excessively increased, resulting in an increase in diameter of each of the lenses positioned behind the first lens group and an increase in a total track length of the optical imaging system.

In an embodiment, the optical imaging system may satisfy the condition 0.4≤LG3/L≤ 0.7, where LG3 may be a distance on the optical axis from the first surface of the reflective member to the third lens group (for example, to an object-side surface of a first lens of the third lens group, or to a stop when the third lens group includes a stop in front of the first lens of the third lens group).

This condition may be related to an amount of movement of the second lens group, which is called a variator. The second lens group may be moved along the optical axis between the fixed first lens group and the fixed third lens group. When a lower limit of the condition 0.4≤ LG3/L≤0.7 is exceeded, a sufficiently high level of zoom magnification may not be achieved. When an upper limit of the condition 0.4≤LG3/L≤0.7 is exceeded, the optical imaging system may have an excessively increased total track length.

In an embodiment, the optical imaging system may satisfy the condition 0.08≤dG2/L≤0.7, where dG2 may be a distance along the optical axis that the second lens group moves from a wide-angle mode of the optical imaging system to a telephoto mode of the optical imaging system.

This condition may be related to an amount of movement of the second lens group or variator. The optical imaging system may satisfy the condition 0.08≤dG2/L≤0.7, thereby securing an appropriate level of zoom magnification and preventing the total track length of the optical imaging system from being excessively increased.

In an embodiment, the optical imaging system may satisfy the condition 1.2≤ Dmax/SD≤1.55, where Dmax may be an effective radius of a lens having a largest effective radius in the second to fourth lens groups, and SD may be a radius of a stop.

When a lower limit of the condition 1.2≤Dmax/SD≤1.55 is exceeded, an F-number Fno of the optical imaging system may excessively increase and an amount of light is reduced accordingly, resulting in a dark image. When an upper limit of the condition 1.2≤Dmax/SD≤ 1.55 is exceeded, a diameter of the stop may excessively increase. As a result, it may be difficult to mount the optical imaging system in the portable electronic device.

In an embodiment, the optical imaging system may satisfy the condition 0.4≤ BFLw/BFLt≤2.8, where BFLw may be a distance from an image-side surface of a last lens of the fourth lens group to the imaging plane in the wide-angle mode, and BFLt may be a distance from the image-side surface of the last lens of the fourth lens group to the imaging plane in the telephoto mode.

The fourth lens group may be moved to correct a focal position according to a change in the total focal length of the optical imaging system. The optical imaging system may satisfy the condition 0.4≤BFLw/BFLt≤2.8, thereby ensuring that there is no change in field curvature even when the total focal length is changed.

In an embodiment, the optical imaging system may satisfy the condition 1.2≤ EPDt/EPDw≤4.4, where EPDw may be an entrance pupil diameter of the optical imaging system in the wide-angle mode, and EPDt may be an entrance pupil diameter of the optical imaging system in the telephoto mode.

In general, Fno in the telephoto mode may be greater than Fno in the wide-angle mode. When Fno of the optical imaging system increases, an amount of light may decrease, resulting in a dark image. In this case, the optical imaging system may be more affected by shaking such as a user's hand tremor. Accordingly, it may be necessary to design the optical imaging system so that a difference in Fno between the wide-angle mode and the telephoto mode is reduced. Accordingly, the optical imaging system may relatively reduce a change in Fno according to a variation in magnification by satisfying the condition 1.2≤EPDt/EPDw≤4.4.

In an embodiment, the optical imaging system may satisfy the condition (n1+n2)/2>1.7, where n1 is a refractive index of the first lens, and n2 is a refractive index of the second lens.

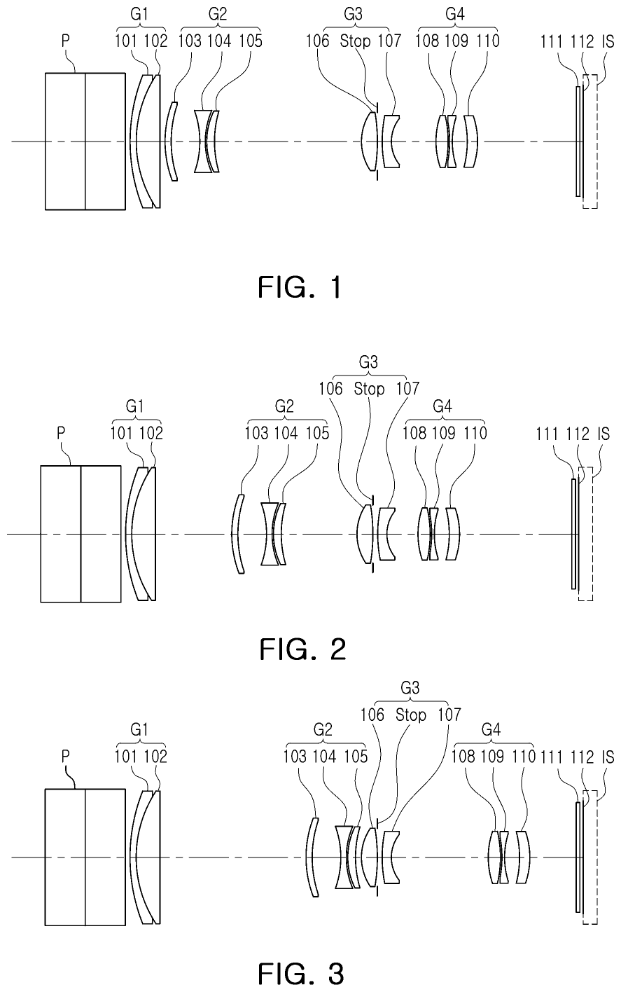

FIG. 1 is a diagram illustrating a wide-angle mode of an optical imaging system according to a first embodiment of the present disclosure. FIG. 2 is a diagram illustrating a normal mode of the optical imaging system of FIG. 1. FIG. 3 is a diagram illustrating a telephoto mode of the optical imaging system of FIG. 1.

The optical imaging system according to the first embodiment of the present disclosure will be described with reference to FIGS. 1 to 3.

The optical imaging system according to the first embodiment of the present disclosure may include a first lens group G1, a second lens group G2, a third lens group G3, and a fourth lens group G4. In addition, the optical imaging system may include a reflective member P disposed in front of the first lens group G1.

In sequence from an object side of the optical imaging system, the first lens group G1 may include a first lens 101 and a second lens 102, the second lens group G2 may include a third lens 103, a fourth lens 104, and a fifth lens 105, the third lens group G3 may include a stop, a sixth lens 106, and a seventh lens 107, and the fourth lens group G4 may include an eighth lens 108, a ninth lens 109, and a tenth lens 110.

In addition, the optical imaging system may further include a filter 111 and an image sensor IS.

The optical imaging system according to the first embodiment of the present disclosure may form a focal point on an imaging plane 112. The imaging plane 112 may refer to a surface on which a focal point is formed by the optical imaging system. As an example, the imaging plane 112 may refer to one surface of the image sensor IS receiving light.

In the first embodiment of the present disclosure, the reflective member P may be a prism, but alternatively may be a mirror.

At least one lens group among the first to fourth lens groups G1 to G4 may be moved to change a total focal length of the optical imaging system. As an example, the first lens group G1 and the third lens group G3 may be fixed and the second lens group G2 may be moved along an optical axis of the optical imaging system to change the total focal length of the optical imaging system. That is, as the second lens group G2 is moved away from an object side of the optical imaging system toward an image side of the optical imaging system, the total focal length of the optical imaging system may be changed from a wide-angle mode to a normal mode to a telephoto mode.

In addition, at least one lens group among the first to fourth lens groups G1 to G4 may be moved to correct a focal position according to a change in the total focal length of the optical imaging system. As an example, when the total focal length of the optical imaging system is changed from the wide-angle mode to the telephoto mode, the fourth lens group G4 may be moved along the optical axis to correct the focal position.

The characteristics of each lens (a radius of curvature, a thickness of a lens or a distance between lenses, a refractive index, and an Abbe number) are listed in Table 1 below.

TABLE 1

| | | | Thick- | Refrac- | | |
|---|---|---|---|---|---|---|
| Surface | Compo- | Radius of | ness or | tive | Abbe | Lens |
| No. | nent | Curvature | Distance | Index | Number | Group |
| Object | | | D0 | | | |
| S1 | Prism | Infinity | 3.6 | 1.5168 | 64.2 | |
| S2 | | Infinity | 3.6 | 1.5168 | 64.2 | |
| S3 | | Infinity | 0.5 | | | |
| S4 | First | 17.423 | 0.45 | 1.94782 | 30.2 | First |
| | Lens | | | | | Lens |
| | | | | | | Group |
| S5 | Second | 10.651 | 2.19 | 1.71402 | 55.2 | |
| | Lens | | | | | |
| S6 | | Infinity | D1 | | | |
| S7 | Third | 12.802 | 0.47 | 1.535 | 55.73 | Second |
| | Lens | | | | | Lens |
| | | | | | | Group |
| S8 | | 10.134 | 2.64 | | | |
| S9 | Fourth | −7.892 | 0.5 | 1.535 | 55.73 | |
| | Lens | | | | | |
| S10 | | 7.919 | 0.1 | | | |
| S11 | Fifth | 6.11 | 0.67 | 1.92286 | 20.88 | |
| | Lens | | | | | |
| S12 | | 8.475 | D2 | | | |
| S13 | Sixth | 4.594 | 1.479 | 1.535 | 55.73 | Third |
| | Lens | | | | | Lens |
| | | | | | | Group |
| S14 | | −14.084 | 0.408 | | | |
| (Stop) | | | | | | |
| S15 | Seventh | 6.28 | 0.826 | 1.6355 | 23.89 | |
| | Lens | | | | | |
| S16 | | 2.697 | D3 | | | |
| S17 | Eighth | 6.973 | 1.02 | 1.535 | 55.73 | Fourth |
| | Lens | | | | | Lens |
| | | | | | | Group |
| S18 | | −13.934 | 0.1 | | | |
| S19 | Ninth | −16.11 | 0.3 | 1.535 | 55.73 | |
| | Lens | | | | | |
| S20 | | 9.472 | 1.33 | | | |
| S21 | Tenth | −12.667 | 0.9 | 1.6355 | 23.89 | |
| | Lens | | | | | |
| S22 | | −9.093 | D4 | | | |
| S23 | Filter | Infinity | 0.21 | 1.5168 | 64.2 | |
| S24 | | Infinity | D5 | | | |
| S25 | Imaging | Infinity | | | | |
| | Plane | | | | | |

TABLE 2

| Object at Infinity | | | | Object at Near Focus Position | | | |
|---|---|---|---|---|---|---|---|
| | Wide-Angle | Normal | Telephoto | | Wide-Angle | Normal | Telephoto |
| Value | Mode | Mode | Mode | Value | Mode | Mode | Mode |
| D0 | Infinity | Infinity | Infinity | D0 | 600 | 600 | 600 |
| D1 | 0.50222 | 6.83785 | 13.20466 | D1 | 0.50222 | 6.83785 | 13.20466 |
| D2 | 13.20244 | 6.86681 | 0.5 | D2 | 13.20244 | 6.86681 | 0.5 |
| D3 | 4.075917 | 2.868768 | 8.784379 | D3 | 3.809635 | 1.997017 | 4.76758 |
| D4 | 9.226423 | 10.43357 | 4.517961 | D4 | 9.492705 | 11.30532 | 8.53476 |
| D5 | 0.1 | 0.1 | 0.1 | D5 | 0.1 | 0.1 | 0.1 |
| f | 11.593 | 21.7643 | 42.565 | MAG | 0.0187 | 0.0350 | 0.0651 |
| HFOV | 12.8 | 6.75 | 3.441 | HFOV | 12.723 | 6.57 | 3.407 |
| Fno | 3.543 | 3.651 | 3.804 | Fno | 3.564 | 3.749 | 3.521 |
| L | 48.4 | 48.4 | 48.4 | L | 48.4 | 48.4 | 48.4 |

In Table 2 above, DO may be an object distance, i.e., a distance on the optical axis between an object and a first surface of the reflective member P, D1 may be a distance on the optical axis between the second lens 102 and the third lens 103, D2 may be a distance on the optical axis between the fifth lens 105 and the sixth lens 106, D3 may be a distance on the optical axis between the seventh lens 107 and the eighth lens 108, D4 may be a distance on the optical axis between the tenth lens 110 and the filter 111, and D5 may be a distance on the optical axis between the filter 111 and the imaging plane 112.

f may be a total focal length of the optical imaging system, MAG may be a magnification of the optical imaging system, HFOV may be one half of a field of view of the optical imaging system, Fno may be a F-number of the optical imaging system, and L may be a distance on the optical axis from a first surface of the reflective member P to the imaging plane 112.

The values in Table 2 above are listed for the wide-angle, normal, and telephoto modes for both an object at infinity and an object at a near focus position of the optical imaging system, i.e., a closest position of the object at which the optical imaging system can focus an image of the object.

A focal length fG1 of the first lens group G1 may be 30.5342 mm, a focal length fG2 of the second lens group G2 may be −9.5675 mm, a focal length fG3 of the third lens group G3 may be 14.9498 mm, and a focal length fG4 of the fourth lens group G4 may be 20.8760 mm.

A focal length of the first lens 101 may be −29.878 mm, a focal length of the second lens 102 may be 14.918 mm, a focal length of the third lens 103 may be −96.836 mm, a focal length of the fourth lens 104 may be −7.308 mm, a focal length of the fifth lens 105 may be 20.886 mm, a focal length of the sixth lens 106 may be 6.659 mm, a focal length of the seventh lens 107 may be −8.170 mm, a focal length of the eighth lens 108 may be 8.837 mm, a focal length of the ninth lens 109 may be −11.104 mm, and a focal length of the tenth lens 110 may be 46.192 mm.

Among the third to tenth lenses 103 to 110, the third lens 103 may have a largest effective radius.

An effective radius of the third lens 103 may be 3.56 mm, and a radius of the stop may be 2.54 mm.

An entrance pupil diameter EPDw of the optical imaging system in the wide-angle mode may be 3.268 mm, and an entrance pupil diameter EPDt of the optical imaging system in the telephoto mode may be 11.2 mm.

In the first embodiment of the present disclosure, the first lens group G1 may generally have a positive refractive power, the second lens group G2 may generally have a negative refractive power, the third lens group G3 may generally have a positive refractive power, and the fourth lens group G4 may generally have a positive refractive power.

The first lens 101 may have a negative refractive power, a first surface of the first lens 101 may be convex, and a second surface of the first lens 101 may be concave.

The second lens 102 may have a positive refractive power, a first surface of the second lens 102 may be convex, and a second surface of the second lens 102 may be flat.

The first lens 101 and the second lens 102 may be bonded to each other to form a bonded lens. The first lens 102 and the second lens 102 may be made of a glass material.

The third lens 103 may have a negative refractive power, a first surface of the third lens 103 may be convex, and a second surface of the third lens 103 may be concave.

The fourth lens 104 may have a negative refractive power, and first and second surfaces of the fourth lens 104 may be concave.

The fifth lens 105 may have a positive refractive power, a first surface of the fifth lens 105 may be convex, and a second surface of the fifth lens 105 may be concave. The fifth lens 105 may be made of a glass material.

The sixth lens 106 may have a positive refractive power, and first and second surfaces of the sixth lens 106 may be convex. The stop may be disposed between the sixth lens 106 and the seventh lens 107. As another example, the stop may be disposed in front of the sixth lens 106.

The seventh lens 107 may have a negative refractive power, a first surface of the seventh lens 107 may be convex, and a second surface of the seventh lens 107 may be concave.

The eighth lens 108 may have a positive refractive power, and first and second surfaces of the eighth lens 108 may be convex.

The ninth lens 109 may have a negative refractive power, and first and second surfaces of the ninth lens 109 may be concave.

The tenth lens 110 may have a positive refractive power, a first surface of the tenth lens 110 may be concave, and a second surface of the tenth lens 110 may be convex.

Surfaces of each of the third lens 103, fourth lens 104, and sixth lens 106 to tenth lens 110 may have aspherical coefficients as listed in Table 3 below. For example, object-side surfaces and image-side surfaces of the remaining lenses, other than the first lens 101, the second lens 102, and the fifth lens 105, may be aspherical surfaces.

TABLE 3

| Value | S7 | S8 | S9 | S10 | S13 | S14 | S15 |
|---|---|---|---|---|---|---|---|
| Conic | 2.051 | −1.129 | 0.455 | 1.026 | −0.217 | −64.223 | −9.344 |
| Constant | | | | | | | |
| (K) | | | | | | | |
| 4th-Order | 2.279E−04 | −1.924E−06 | −2.044E−04 | 2.331 E−04 | 2.087E−04 | 1.980E−04 | −1.982E−03 |
| Coefficient | | | | | | | |
| (A) | | | | | | | |
| 6th-Order | 4.900E−05 | 7.836E−05 | 2.550E−05 | 5.451 E−05 | 7.694E−05 | 3.305E−05 | −2.248E−04 |
| Coefficient | | | | | | | |
| (B) | | | | | | | |
| 8th-Order | −9.489E−07 | −1.059E−05 | 5.412E−06 | −9.901E−09 | −1.556E−05 | −1.985E−05 | 2.218E−05 |
| Coefficient | | | | | | | |
| (C) | | | | | | | |
| 10th-Order | −6.440E−07 | 6.238E−07 | −1.230E−06 | −1.692E−07 | 1.906E−06 | 3.655E−07 | 6.886E−07 |
| Coefficient | | | | | | | |
| (D) | | | | | | | |
| Value | S16 | S17 | S18 | S19 | S20 | S21 | S22 |
| Conic | −0.845 | −1.745 | 9.360 | 43.685 | −24.487 | 29.271 | 11.723 |
| Constant | | | | | | | |
| (K) | | | | | | | |
| 4th-Order | −8.537E−03 | −8.661E−04 | −3.593E−04 | −2.288E−03 | −5.615E−03 | −7.722E−03 | −3.363E−03 |
| Coefficient | | | | | | | |
| (A) | | | | | | | |
| 6th-Order | 6.394E−04 | 1.783E−05 | −1.893E−04 | 1.324E−03 | 2.221 E−03 | 6.831E−04 | 5.622E−04 |
| Coefficient | | | | | | | |
| (B) | | | | | | | |
| 8th-Order | 7.599E−06 | −3.577E−05 | −2.243E−05 | 4.780E−04 | 3.773E−04 | 4.988E−04 | 1.477E−04 |
| Coefficient | | | | | | | |
| (C) | | | | | | | |
| 10th-Order | 2.474E−06 | −4.124E−06 | 2.963E−06 | −1.294E−04 | −9.061E−05 | −5.293E−05 | −1.094E−05 |
| Coefficient | | | | | | | |
| (D) | | | | | | | |

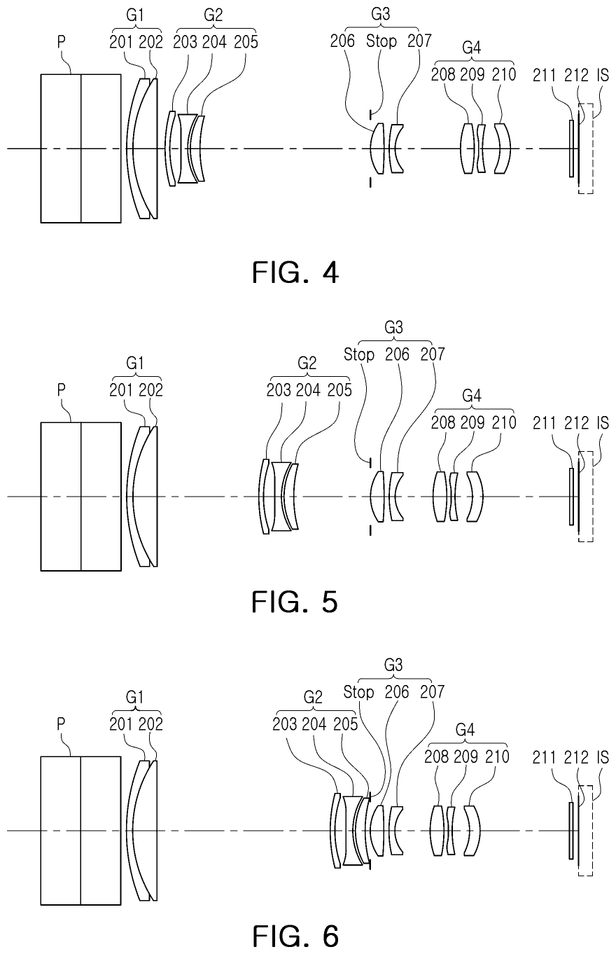

FIG. 4 is a diagram illustrating a wide-angle mode of an optical imaging system according to a second embodiment of the present disclosure. FIG. 5 is a diagram illustrating a normal mode of the optical imaging system of FIG. 4. FIG. 6 is a diagram illustrating a telephoto mode of the optical imaging system of FIG. 4.

The optical imaging system according to the second embodiment of the present disclosure will be described with reference to FIGS. 4 to 6.

The optical imaging system according to the second embodiment of the present disclosure may include a first lens group G1, a second lens group G2, a third lens group G3, and a fourth lens group G4. In addition, the optical imaging system may include a reflective member P disposed in front of the first lens group G1.

In sequence from an object side of the optical imaging system, the first lens group G1 may include a first lens 201 and a second lens 202, the second lens group G2 may include a third lens 203, a fourth lens 204, and a fifth lens 205, the third lens group G3 may include a stop, a sixth lens 206, and a seventh lens 207, and the fourth lens group G4 may include an eighth lens 208, a ninth lens 209, and a tenth lens 210.

In addition, the optical imaging system may further include a filter 211 and an image sensor IS.

The optical imaging system according to the second embodiment of the present disclosure may form a focal point on an imaging plane 212. The imaging plane 212 may refer to a surface on which a focal point is formed by the optical imaging system. As an example, the imaging plane 212 may refer to one surface of the image sensor IS receiving light.

In the second embodiment of the present disclosure, the reflective member P may be a prism, but alternatively may be a mirror.

At least one lens group among the first to fourth lens groups G1 to G4 may be moved to change a total focal length of the optical imaging system. As an example, the first lens group G1 and the third lens group G3 may be fixed and the second lens group G2 may be moved along an optical axis of the optical imaging system to change the total focal length of the optical imaging system. That is, as the second lens group G2 is moved away from an object side of the optical imaging system toward an image side of the optical imaging system, the total focal length of the optical imaging system may be changed from a wide-angle mode to a normal mode to a telephoto mode.

In addition, at least one lens group among the first to fourth lens groups G1 to G4 may be moved to correct a focal position according to a change in the total focal length of the optical imaging system. As an example, when the total focal length of the optical imaging system is changed from the wide-angle mode to the telephoto mode, the fourth lens group G4 may be moved along the optical axis to correct the focal position.

The characteristics of each lens (a radius of curvature, a thickness of a lens or a distance between lenses, a refractive index, and an Abbe number) are listed in Table 4 below.

TABLE 4

| | | | Thick- | Refrac- | | |
|---|---|---|---|---|---|---|
| Surface | Compo- | Radius of | ness or | tive | Abbe | Lens |
| No. | nent | Curvature | Distance | Index | Number | Group |
| Object | | | D0 | | | |
| S1 | Prism | Infinity | 3.55 | 1.5168 | 64.2 | |
| S2 | | Infinity | 3.55 | 1.5168 | 64.2 | |
| S3 | | Infinity | 0.5 | | | |
| S4 | First | 16.449 | 0.45 | 1.95375 | 32.32 | First |
| | Lens | | | | | Lens |
| S5 | Second | 11.038 | 2.3 | 1.618 | 63.4 | Group |
| S6 | Lens | Infinity | D1 | | | |
| S7 | Third | 22.059 | 0.3 | 1.535 | 55.73 | Second |
| S8 | Lens | 6.69 | 1.101 | | | Lens |
| S9 | Fourth | 44.002 | 0.5 | 1.535 | 55.73 | Group |
| S10 | Lens | 5.014 | 0.212 | | | |
| S11 | Fifth | 4.268 | 0.92 | 1.6355 | 23.89 | |
| S12 | Lens | 6.353 | D2 | | | |
| | Stop | Infinity | 0 | | | Third |
| S13 | Sixth | 3.994 | 1.24 | 1.535 | 55.73 | Lens |
| S14 | Lens | −39.674 | 0.454 | | | Group |
| S15 | Seventh | 5.851 | 0.55 | 1.6355 | 23.89 | |
| S16 | Lens | 2.839 | D3 | | | |
| S17 | Eighth | 5.242 | 1.14 | 1.535 | 55.73 | Fourth |
| S18 | Lens | −26.662 | 0.472 | | | Lens |
| S19 | Ninth | −16.427 | 0.31 | 1.535 | 55.73 | Group |
| S20 | Lens | 9.332 | 1.612 | | | |
| S21 | Tenth | −12.532 | 0.9 | 1.6355 | 23.89 | |
| S22 | Lens | −10.419 | D4 | | | |
| S23 | Filter | Infinity | 0.21 | 1.5168 | 64.2 | |
| S24 | | Infinity | D5 | | | |
| S25 | Imaging | Infinity | | | | |
| | Plane | | | | | |

TABLE 5

| Object at Infinity | | | | Object at Near Focus Position | | | |
|---|---|---|---|---|---|---|---|
| | Wide-Angle | Normal | Telephoto | | Wide-Angle | Normal | Telephoto |
| Value | Mode | Mode | Mode | Value | Mode | Mode | Mode |
| D0 | Infinity | Infinity | Infinity | D0 | 600 | 600 | 600 |
| D1 | 0.738 | 9.213 | 15.425 | D1 | 0.738 | 9.213 | 15.425 |
| D2 | 15.187 | 6.712 | 0.5 | D2 | 15.187 | 6.712 | 0.5 |
| D3 | 5.807257 | 3.282505 | 3.13163 | D3 | 5.6618 | 2.709094 | 1.105418 |
| D4 | 5.381743 | 7.906495 | 8.05737 | D4 | 5.5272 | 8.479906 | 10.08358 |
| D5 | 0.5 | 0.5 | 0.5 | D5 | 0.5 | 0.5 | 0.5 |
| f | 8.4070 | 17.9209 | 33.5848 | MAG | 0.0136 | 0.0287 | 0.0559 |
| HFOV | 17.427 | 8.157 | 4.363 | HFOV | 17.389 | 8.001 | 4.034 |
| Fno | 3.501 | 3.741 | 3.759 | Fno | 3.511 | 3.821 | 4.088 |
| L | 47.885 | 47.885 | 47.885 | L | 47.885 | 47.885 | 47.885 |

In Table 5 above, DO may be an object distance, i.e., a distance on the optical axis between an object and a first surface of the reflective member P, D1 may be a distance on the optical axis between the second lens 202 and the third lens 203, D2 may be a distance on the optical axis between the fifth lens 205 and the stop, D3 may be a distance on the optical axis between the seventh lens 207 and the eighth lens 208, D4 may be a distance on the optical axis between the tenth lens 210 and the filter 111, and D5 may be a distance on the optical axis between the filter 211 and the imaging plane 212.

f may be a total focal length of the optical imaging system, MAG may be a magnification of the optical imaging system, HFOV may be one half of a field of view of the optical imaging system, Fno may be a F-number of the optical imaging system, and L may be a distance on the optical axis from a first surface of the reflective member P to the imaging plane 212.

The values in Table 5 above are listed for the wide-angle, normal, and telephoto modes for both an object at infinity and an object at a near focus position of the optical imaging system, i.e., a closest position of the object at which the optical imaging system can focus an image of the object.

A focal length fG1 of the first lens group G1 may be 35.7392 mm, a focal length fG2 of the second lens group G2 may be −9.7724 mm, a focal length fG3 of the third lens group G3 may be 14.5797 mm, and a focal length fG4 of the fourth lens group G4 may be 19.3917 mm.

A focal length of the first lens 201 may be −36.671 mm, a focal length of the second lens 202 may be 17.863 mm, a focal length of the third lens 203 may be −18.071 mm, a focal length of the fourth lens 204 may be −10.625 mm, a focal length of the fifth lens 205 may be 17.469 mm, a focal length of the sixth lens 206 may be 6.850 mm, a focal length of the seventh lens 207 may be −9.341 mm, a focal length of the eighth lens 208 may be 8.292 mm, a focal length of the ninth lens 209 may be −11.077 mm, and a focal length of the tenth lens 210 may be 83.429 mm.

Among the third to tenth lenses 203 to 210, the third lens 203 may have a largest effective radius.

An effective radius of the third lens 203 may be 3.44 mm, and a radius of the stop may be 2.35 mm.

An entrance pupil diameter EPDw of the optical imaging system in the wide-angle mode may be 2.398 mm, and an entrance pupil diameter EPDt of the optical imaging system in the telephoto mode may be 8.93 mm.

In the second embodiment of the present disclosure, the first lens group G1 may generally have a positive refractive power, the second lens group G2 may generally have a negative refractive power, the third lens group G3 may generally have a positive refractive power, and the fourth lens group G4 may generally have a positive refractive power.

The first lens 201 may have a negative refractive power, a first surface of the first lens 201 may be convex, and a second surface of the first lens 201 may be concave.

The second lens 202 may have a positive refractive power, a first surface of the second lens 202 may be convex, and a second surface of the second lens 202 may be flat.

The first lens 201 and the second lens 202 may be bonded lenses bonded to each other.

The third lens 203 may have a negative refractive power, a first surface of the third lens 203 may be convex, and a second surface of the third lens 203 may be concave.

The fourth lens 204 may have a negative refractive power, a first surface of the fourth lens 204 may be convex, and a second surface of the fourth lens 204 may be concave.

The fifth lens 205 may have a positive refractive power, a first surface of the fifth lens 205 may be convex, and a second surface of the fifth lens 205 may be concave.

The sixth lens 206 may have a positive refractive power, and first and second surfaces of the sixth lens 206 may be convex. The stop may be disposed at the same position on the optical axis as the first surface of the sixth lens 206, i.e., an object-side surface of the sixth lens 206.

The seventh lens 207 may have a negative refractive power, a first surface of the seventh lens 207 may be convex, and a second surface of the seventh lens 207 may be concave.

The eighth lens 208 may have a positive refractive power, and first and second surfaces of the eighth lens 208 may be convex.

The ninth lens 209 may have a negative refractive power, and first and second surfaces of the ninth lens 209 may be concave.

The tenth lens 210 may have a positive refractive power, a first surface of the tenth lens 210 may be concave, and a second surface of the tenth lens 210 may be convex.

Surfaces of each of the third lens 203 to ninth lens 209 may have aspherical coefficients as listed in Table 6 below. For example, object-side surfaces and image-side surfaces of the remaining lenses, other than the first lens 201, the second lens 202, and the tenth lens 210, may be aspherical surfaces.

TABLE 6

| Value | S7 | S8 | S9 | S10 | S11 | S12 | S13 |
|---|---|---|---|---|---|---|---|
| Conic | −11.888 | −4.283 | −80.000 | 0.742 | −1.019 | −7.823 | −0.358 |
| Constant | | | | | | | |
| (K) | | | | | | | |
| 4th-Order | 8.532E−04 | −2.045E−04 | −3.749E−03 | 1.049E−03 | −1.370E−03 | −1.902E−03 | −4.423E−05 |
| Coefficient | | | | | | | |
| (A) | | | | | | | |
| 6th-Order | 5.841E−05 | 1.005E−04 | −1.721E−06 | −2.557E−04 | −3.456E−05 | −3.175E−05 | 2.936E−05 |
| Coefficient | | | | | | | |
| (B) | | | | | | | |
| 8th-Order | −5.530E−06 | −9.974E−06 | 9.054E−07 | −3.108E−05 | −1.247E−05 | 1.061E−05 | −1.411E−05 |
| Coefficient | | | | | | | |
| (C) | | | | | | | |
| 10th-Order | −2.752E−07 | −4.987E−07 | −2.419E−06 | −1.052E−06 | −8.714E−08 | −1.246E−06 | 7.531 E−07 |
| Coefficient | | | | | | | |
| (D) | | | | | | | |
| Value | S14 | S15 | S16 | S17 | S18 | S19 | S20 |
| Conic | −56.124 | −10.646 | −0.639 | −0.798 | −80.000 | 46.570 | −18.484 |
| Constant | | | | | | | |
| (K) | | | | | | | |
| 4th-Order | 1.448E−04 | −1.224E−03 | −7.041E−03 | −1.591E−04 | 1.008E−03 | 1.394E−05 | −7.638E−03 |
| Coefficient | | | | | | | |
| (A) | | | | | | | |
| 6th-Order | −2.614E−05 | −5.949E−05 | 1.010E−03 | −1.790E−05 | −6.433E−04 | 1.963E−03 | 2.863E−03 |
| Coefficient | | | | | | | |
| (B) | | | | | | | |
| 8th-Order | −1.802E−05 | 3.593E−05 | −5.414E−05 | −1.417E−04 | −9.773E−05 | 5.043E−04 | 4.425E−04 |
| Coefficient | | | | | | | |
| (C) | | | | | | | |
| 10th-Order | 8.344E−07 | −3.481E−07 | 1.010E−05 | −7.750E−07 | 2.329E−06 | −1.521E−04 | −1.212E−04 |
| Coefficient | | | | | | | |
| (D) | | | | | | | |

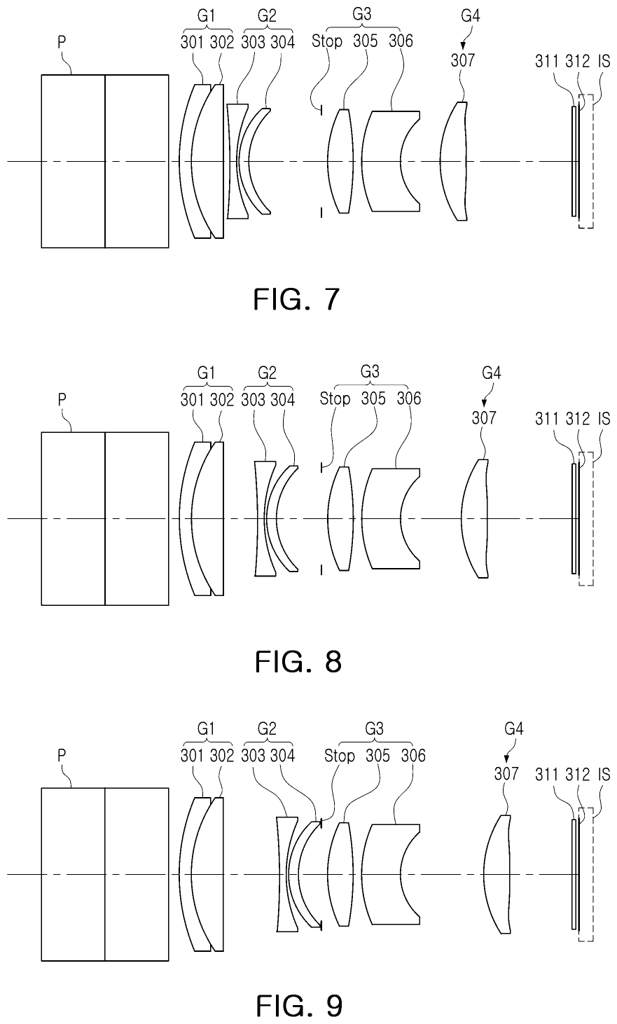

FIG. 7 is a diagram illustrating a wide-angle mode of an optical imaging system according to a third embodiment of the present disclosure. FIG. 8 is a diagram illustrating a normal mode of the optical imaging system of FIG. 7. FIG. 9 is a diagram illustrating a telephoto mode of the optical imaging system of FIG. 7.

The optical imaging system according to the third embodiment of the present disclosure will be described with reference to FIGS. 7 to 9.

The optical imaging system according to the third embodiment of the present disclosure may include a first lens group G1, a second lens group G2, a third lens group G3, and a fourth lens group G4. In addition, the optical imaging system may include a reflective member P disposed in front of the first lens group G1.

In sequence from an object side of the optical imaging system, the first lens group G1 may include a first lens 301 and a second lens 302, the second lens group G2 may include a third lens 303 and a fourth lens 304, the third lens group G3 may include a stop, a fifth lens 305, and a sixth lens 306, and the fourth lens group G4 may include a seventh lens 307.

In addition, the optical imaging system may further include a filter 311 and an image sensor IS.

The optical imaging system according to the third embodiment of the present disclosure may form a focal point on an imaging plane 312. The imaging plane 312 may refer to a surface on which a focal point is formed by the optical imaging system. As an example, the imaging plane 312 may refer to one surface of the image sensor IS receiving light.

In the third embodiment of the present disclosure, the reflective member P may be a prism, but alternatively may be a mirror.

At least one lens group among the first to fourth lens groups G1 to G4 may be moved to change a total focal length of the optical imaging system. As an example, the first lens group G1 and the third lens group G3 may be fixed and the second lens group G2 may be moved along an optical axis of the optical imaging system to change the total focal length of the optical imaging system may be changed. That is, as the second lens group G2 is moved away from an object side of the optical imaging system toward an image side of the optical imaging system, the total focal length of the optical imaging system may be changed from a wide-angle mode to a normal mode to a telephoto mode.

In addition, at least one lens group among the first to fourth lens groups G1 to G4 may be moved to correct a focal position according to a change in the total focal length of the optical imaging system. As an example, when the total focal length of the optical imaging system is changed from the wide-angle mode to the telephoto mode, the fourth lens group G4 may be moved along the optical axis to correct the focal position.

The characteristics of each lens (a radius of curvature, a thickness of a lens or a distance between lenses, a refractive index, and an Abbe number) are listed in Table 7 below.

TABLE 7

| | | | Thick- | Refrac- | | |
|---|---|---|---|---|---|---|
| Surface | Compo- | Radius of | ness or | tive | Abbe | Lens |
| No. | nent | Curvature | Distance | Index | Number | Group |
| Object | | | D0 | | | |
| S1 | Prism | Infinity | 3 | 1.5168 | 64.2 | |
| S2 | | Infinity | 3 | 1.5168 | 64.2 | |
| S3 | | Infinity | 0.5 | | | |
| S4 | First | 10.435 | 0.5 | 1.80518 | 25.46 | First |
| | Lens | | | | | Lens |
| | | | | | | Group |
| S5 | Second | 6.545 | 1.5 | 1.72916 | 54.67 | |
| | Lens | | | | | |
| S6 | | Infinity | D1 | | | |
| S7 | Third | −28.594 | 0.3 | 1.535 | 55.73 | Second |
| | Lens | | | | | Lens |
| | | | | | | Group |
| S8 | | 6.027 | 0.114 | | | |
| S9 | Fourth | 3.203 | 0.462 | 1.6355 | 23.89 | |
| | Lens | | | | | |
| S10 | | 3.191 | D2 | | | |
| S11 | | Infinity | 0.292 | | | Third |
| (Stop) | | | | | | Lens |
| | | | | | | Group |
| S12 | Fifth | 5.35 | 1.177 | 1.535 | 55.73 | |
| | Lens | | | | | |
| S13 | | −10.211 | 0.447 | | | |
| S14 | Sixth | 4.995 | 1.694 | 1.6355 | 23.89 | |
| | Lens | | | | | |
| S15 | | 2.065 | D3 | | | |
| S16 | Seventh | 6.443 | 1.2 | 1.535 | 55.73 | Fourth |
| | Lens | | | | | Lens |
| | | | | | | Group |
| S17 | | −35.523 | D4 | | | |
| S18 | Filter | Infinity | 0.21 | 1.5168 | 64.2 | |
| S19 | | Infinity | D5 | | | |
| S20 | Imaging | Infinity | | | | |
| | Plane | | | | | |

TABLE 8

| Object at Infinity | | | | Object at Near Focus Position | | | |
|---|---|---|---|---|---|---|---|
| | Wide-Angle | Normal | Telephoto | | Wide-Angle | Normal | Telephoto |
| Value | Mode | Mode | Mode | Value | Mode | Mode | Mode |
| D0 | Infinity | Infinity | Infinity | D0 | 400 | 400 | 400 |
| D1 | 0.28445 | 1.58822 | 2.53798 | D1 | 0.28445 | 1.58822 | 2.53798 |
| D2 | 3.37577 | 2.072 | 1.12224 | D2 | 3.37577 | 2.072 | 1.12224 |
| D3 | 1.890039 | 2.863645 | 3.98444 | D3 | 1.517221 | 2.327039 | 3.205345 |
| D4 | 4.953741 | 3.980135 | 2.85934 | D4 | 5.326559 | 4.516741 | 3.638435 |
| D5 | 0.1 | 0.1 | 0.1 | D5 | 0.1 | 0.1 | 0.1 |
| f | 11.2051 | 12.8497 | 14.4922 | MAG | 0.0276 | 0.0314 | 0.0347 |
| HFOV | 13.119 | 11.442 | 10.067 | HFOV | 12.882 | 11.313 | 10.206 |
| Fno | 2.382 | 2.337 | 2.362 | Fno | 2.411 | 2.35 | 2.332 |
| L | 25 | 25 | 25 | L | 25 | 25 | 25 |

In Table 8 above, DO may be an object distance, i.e., a distance on the optical axis between an object and a first surface of the reflective member P, D1 may be a distance on the optical axis between the second lens 302 and the third lens 303, D2 may be a distance on the optical axis between the fourth lens 304 and the stop, D3 may be a distance on the optical axis between the sixth lens 306 and the seventh lens 307, D4 may be a distance on the optical axis between the seventh lens 307 and the filter 311, and D5 may be a distance on the optical axis between the filter 311 and the imaging plane 312.

f may be a total focal length of the optical imaging system, MAG may be a magnification of the optical imaging system, HFOV may be one half of a field of view of the optical imaging system, Fno may be a F-number of the optical imaging system, and L may be a distance on the optical axis from an object-side surface of the first lens 301 to the imaging plane 312.

The values in Table 8 above are listed for the wide-angle, normal, and telephoto modes for both an object at infinity and an object at a near focus position of the optical imaging system, i.e., a closest position of the object at which the optical imaging system can focus an image of the object.

A focal length fG1 of the first lens group G1 may be 15.1816 mm, a focal length fG2 of the second lens group G2 may be −9.6820 mm, a focal length fG3 of the third lens group G3 may be 13.2062 mm, and a focal length fG4 of the fourth lens group G4 may be 10.2967 mm.

A focal length of the first lens 301 may be −23.131 mm, a focal length of the second lens 302 may be 8.977 mm, a focal length of the third lens 303 may be −9.276 mm, a focal length of the fourth lens 304 may be 96.008 mm, a focal length of the fifth lens 305 may be 6.740 mm, a focal length of the sixth lens 306 may be −7.145 mm, and a focal length of the seventh lens 307 may be 10.297 mm.

Among the third to seventh lenses 303 to 307, the third lens 303 may have a largest effective radius.

An effective radius of the third lens 303 may be 2.73 mm, and a radius of the stop may be 2.2 mm.

An entrance pupil diameter EPDw of the optical imaging system in the wide-angle mode may be 4.702 mm, and an entrance pupil diameter EPDt of the optical imaging system in the telephoto mode may be 6.14 mm.

In the third embodiment of the present disclosure, the first lens group G1 may generally have a positive refractive power, the second lens group G2 may generally have a negative refractive power, the third lens group G3 may generally have a positive refractive power, and the fourth lens group G4 may generally have a positive refractive power.

The first lens 301 may have a negative refractive power, a first surface of the first lens 301 may be convex, and a second surface of the first lens 301 may be concave.

The second lens 302 may have a positive refractive power, a first surface of the second lens 302 may be convex, and a second surface of the second lens 302 may be flat.

The first lens 301 and the second lens 302 may be bonded lenses bonded to each other.

The third lens 303 may have a negative refractive power, and first and second surfaces of the third lens 303 may be concave.

The fourth lens 304 may have a positive refractive power, a first surface of the fourth lens 304 may be convex, and a second surface of the fourth lens 304 may be concave.

The fifth lens 305 may have a positive refractive power, and first and second surfaces of the fifth lens 305 may be convex. The stop may be disposed in front of the fifth lens 305.

The sixth lens 306 may have a negative refractive power, a first surface of the sixth lens 306 may be convex, and a second surface of the sixth lens 306 may be concave.

The seventh lens 307 may have a positive refractive power, and first and second surfaces of the seventh lens 307 may be convex.

Surfaces of each of the third lens 303 to seventh lens 307 may have aspherical coefficients as listed in Table 9 below. For example, object-side surfaces and image-side surfaces of the remaining lenses, other than the first lens 301 and the second lens 302, may be aspherical surfaces.

TABLE 9

| Value | S7 | S8 | S9 | S10 | S12 |
|---|---|---|---|---|---|
| Conic | 4.865 | −0.063 | −0.120 | −0.156 | −0.264 |
| Constant | | | | | |
| (K) | | | | | |
| 4th-Order | −2.590E−05 | −3.984E−05 | −1.162E−03 | −1.144E−03 | 2.874E−05 |
| Coefficient | | | | | |
| (A) | | | | | |
| 6th-Order | −3.487E−06 | −1.197E−05 | −7.679E−05 | 4.358E−06 | 8.479E−05 |
| Coefficient | | | | | |
| (B) | | | | | |
| 8th-Order | −4.223E−07 | −1.188E−06 | 2.947E−06 | −3.277E−06 | −1.181E−05 |
| Coefficient | | | | | |
| (C) | | | | | |
| 10th-Order | 7.342E−08 | 2.863E−09 | −4.138E−07 | −3.900E−07 | 1.848E−06 |
| Coefficient | | | | | |
| (D) | | | | | |

| Value | S13 | S14 | S15 | S16 | S17 |
|---|---|---|---|---|---|
| Conic | −22.837 | −1.987 | −0.427 | 0.187 | 56.602 |
| Constant | | | | | |
| (K) | | | | | |
| 4th-Order | 3.905E−04 | −7.644E−04 | −1.199E−02 | 1.308E−03 | 1.844E−03 |
| Coefficient | | | | | |
| (A) | | | | | |
| 6th-Order | 5.459E−05 | −8.250E−05 | −1.266E−04 | −5.496E−05 | −1.703E−04 |
| Coefficient | | | | | |
| (B) | | | | | |
| 8th-Order | −1.253E−05 | −1.363E−06 | −4.553E−05 | 1.686E−05 | 3.432E−05 |
| Coefficient | | | | | |
| (C) | | | | | |
| 10th-Order | 7.925E−07 | −1.756E−06 | −1.038E−05 | 2.464E−06 | −9.099E−07 |
| Coefficient | | | | | |
| (D) | | | | | |

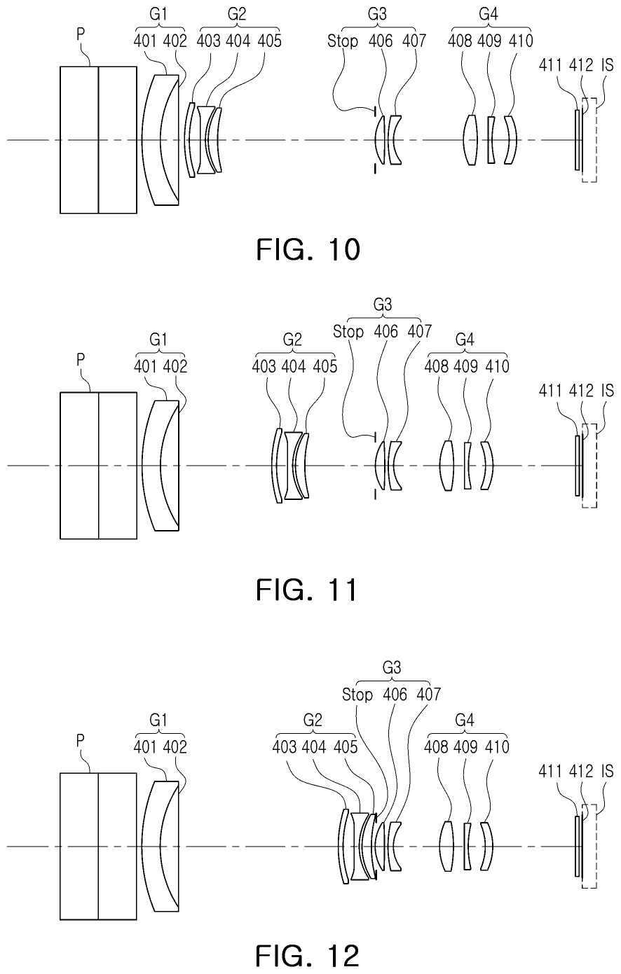

FIG. 10 is a diagram illustrating a wide-angle mode of an optical imaging system according to a fourth embodiment of the present disclosure. FIG. 11 is a diagram illustrating a normal mode of the optical imaging system of FIG. 10. FIG. 12 is a diagram illustrating a telephoto mode of the optical imaging system of FIG. 10.

The optical imaging system according to the fourth embodiment of the present disclosure will be described with reference to FIGS. 10 to 12.

The optical imaging system according to the fourth embodiment of the present disclosure may include a first lens group G1, a second lens group G2, a third lens group G3, and a fourth lens group G4. In addition, the optical imaging system may include a reflective member P disposed in front of the first lens group G1.

In sequence from an object side of the optical imaging system, the first lens group G1 may include a first lens 401 and a second lens 402, the second lens group G2 may include a third lens 403, a fourth lens 404, and a fifth lens 405, the third lens group G3 may include a stop, a sixth lens 406, and a seventh lens 407, and the fourth lens group G4 may include an eighth lens 408, a ninth lens 409, and a tenth lens 410.

In addition, the optical imaging system may further include a filter 411 and an image sensor IS.

The optical imaging system according to the fourth embodiment of the present disclosure may form a focal point on an imaging plane 412. The imaging plane 412 may refer to a surface on which a focal point is formed by the optical imaging system. As an example, the imaging plane 412 may refer to one surface of the image sensor IS receiving light.

In the fourth embodiment of the present disclosure, the reflective member P may be a prism, but alternatively may be a mirror.

At least one lens group among the first to fourth lens groups G1 to G4 may be moved to change a total focal length of the optical imaging system. As an example, the first lens group G1 and the third lens group G3 may be fixed and the second lens group G2 may be moved along an optical axis of the optical imaging system to change the total focal length of the optical imaging system may be changed. That is, as the second lens group G2 is moved away from an object side of the optical imaging system toward an image side of the optical imaging system, the total focal length of the optical imaging system may be changed from a wide-angle mode to a normal mode to a telephoto mode.

In addition, at least one lens group among the first to fourth lens groups G1 to G4 may be moved to correct a focal position according to a change in the total focal length of the optical imaging system. As an example, when the total focal length of the optical imaging system is changed from the wide-angle mode to the telephoto mode, the fourth lens group G4 may be moved along the optical axis to correct the focal position.

The characteristics of each lens (a radius of curvature, a thickness of a lens or a distance between lenses, a refractive index, and an Abbe number) are listed in Table 10 below.

TABLE 10

| | | | Thick- | Refrac- | | |
|---|---|---|---|---|---|---|
| Surface | Compo- | Radius of | ness or | tive | Abbe | Lens |
| No. | nent | Curvature | Distance | Index | Number | Group |
| Object | | | D0 | | | |
| S1 | Prism | Infinity | 3.55 | 1.5168 | 64.2 | |
| S2 | | Infinity | 3.55 | 1.5168 | 64.2 | |
| S3 | | Infinity | 0.5 | | | |
| S4 | First | 16.648 | 1.69 | 1.95375 | 32.32 | First |
| | Lens | | | | | Lens |
| S5 | Second | 10.84 | 1.71 | 1.618 | 63.4 | Group |
| S6 | Lens | Infinity | D1 | | | |
| S7 | Third | 21.598 | 0.37 | 1.535 | 55.73 | Second |
| | Lens | | | | | Lens |
| S8 | | 7.408 | 1.108 | | | Group |
| S9 | Fourth | 109.533 | 0.4 | 1.535 | 55.73 | |
| | Lens | | | | | |
| S10 | | 4.97 | 0.241 | | | |
| S11 | Fifth | 4.279 | 0.83 | 1.6355 | 23.89 | |
| | Lens | | | | | |
| S12 | | 6.226 | D2 | | | |
| | Stop | Infinity | 0 | | | Third |
| S13 | Sixth | 3.913 | 0.79 | 1.535 | 55.73 | Lens |
| | Lens | | | | | Group |
| S14 | | −52.001 | 0.36 | | | |
| S15 | Seventh | 5.846 | 0.48 | 1.6355 | 23.89 | |
| | Lens | | | | | |
| S16 | | 2.813 | D3 | | | |
| S17 | Eighth | 4.799 | 1.18 | 1.535 | 55.73 | Fourth |
| | Lens | | | | | Lens |
| S18 | | −50.63 | 1.08 | | | Group |
| S19 | Ninth | −16.487 | 0.31 | 1.535 | 55.73 | |
| | Lens | | | | | |
| S20 | | 9.319 | 1.611 | | | |
| S21 | Tenth | −12.594 | 0.63 | 1.6355 | 23.89 | |
| | Lens | | | | | |
| S22 | | −9.88 | D4 | | | |
| S23 | Filter | Infinity | 0.21 | 1.5168 | 64.2 | |
| S24 | | Infinity | D5 | | | |
| S25 | Imaging | Infinity | | | | |
| | Plane | | | | | |

TABLE 11

| Object at Infinity | | | | Object at Near Focus Position | | | |
|---|---|---|---|---|---|---|---|
| | Wide-Angle | Normal | Telephoto | | Wide-Angle | Normal | Telephoto |
| Value | Mode | Mode | Mode | Value | Mode | Mode | Mode |
| D0 | Infinity | Infinity | Infinity | D0 | 600 | 600 | 600 |
| D1 | 0.55762 | 8.71722 | 14.85514 | D1 | 0.55762 | 8.71722 | 14.85514 |
| D2 | 14.61806 | 6.45846 | 0.32054 | D2 | 14.61806 | 6.45846 | 0.32054 |
| D3 | 6.534452 | 4.390088 | 4.203084 | D3 | 6.410039 | 3.868906 | 2.286853 |
| D4 | 5.774868 | 7.919232 | 8.106236 | D4 | 5.899281 | 8.440414 | 10.02247 |
| D5 | 0.1 | 0.1 | 0.1 | D5 | 0.1 | 0.1 | 0.1 |
| f | 8.3502 | 17.7838 | 33.5789 | MAG | 0.0135 | 0.0285 | 0.0566 |
| HFOV | 17.454 | 8.122 | 4.3 | HFOV | 17.397 | 7.946 | 3.935 |
| Fno | 3.348 | 3.618 | 3.648 | Fno | 3.36 | 3.704 | 4.021 |
| L | 48.185 | 48.185 | 48.185 | L | 48.185 | 48.185 | 48.185 |

In Table 11 above, DO may be an object distance, i.e., a distance on the optical axis between an object and a first surface of the reflective member P, D1 may be a distance on the optical axis between the second lens 402 and the third lens 403, D2 may be a distance on the optical axis between the fifth lens 405 and the stop, D3 may be a distance on the optical axis between the seventh lens 407 and the eighth lens 408, D4 may be a distance on the optical axis between the tenth lens 410 and the filter 411, and D5 may be a distance on the optical axis between the filter 411 and the imaging plane 412.

f may be a total focal length of the optical imaging system, MAG may be a magnification of the optical imaging system, HFOV may be one half of a field of view of the optical imaging system, Fno may be a F-number of the optical imaging system, and L may be a distance on the optical axis from a first surface of the reflective member P to the imaging plane 412.

The values in Table 11 above are listed for the wide-angle, normal, and telephoto modes for both an object at infinity and an object at a near focus position of the optical imaging system, i.e., a closest position of the object at which the optical imaging system can focus an image of the object.

A focal length fG1 of the first lens group G1 may be 35.9056 mm, a focal length fG2 of the second lens group G2 may be −9.5692 mm, a focal length fG3 of the third lens group G3 may be 16.8011 mm, and a focal length fG4 of the fourth lens group G4 may be 16.4336 mm.

A focal length of the first lens 401 may be −37.972 mm, a focal length of the second lens 402 may be 17.542 mm, a focal length of the third lens 403 may be −21.269 mm, a focal length of the fourth lens 404 may be −9.744 mm, a focal length of the fifth lens 405 may be 18.472 mm, a focal length of the sixth lens 406 may be 6.836 mm, a focal length of the seventh lens 407 may be −9.091 mm, a focal length of the eighth lens 408 may be 8.255 mm, a focal length of the ninth lens 409 may be −11.082 mm, and a focal length of the tenth lens 410 may be 66.174 mm.

Among the third to tenth lenses 403 to 410, the third lens 403 may have a largest effective radius.

An effective radius of the third lens 403 may be 3.25 mm, and a radius of the stop may be 2.35 mm.

An entrance pupil diameter EPDw of the optical imaging system in the wide-angle mode may be 2.488 mm, and an entrance pupil diameter EPDt of the optical imaging system in the telephoto mode may be 9.21 mm.

In the fourth embodiment of the present disclosure, the first lens group G1 may generally have a positive refractive power, the second lens group G2 may generally have a negative refractive power, the third lens group G3 may generally have a positive refractive power, and the fourth lens group G4 may generally have a positive refractive power.

The first lens 401 may have a negative refractive power, a first surface of the first lens 401 may be convex, and a second surface of the first lens 401 may be concave.

The second lens 402 may have a positive refractive power, a first surface of the second lens 402 may be convex, and a second surface of the second lens 402 may be flat.

The first lens 401 and the second lens 402 may be bonded lenses bonded to each other.

The third lens 403 may have a negative refractive power, a first surface of the third lens 403 may be convex, and a second surface of the third lens 403 may be concave.

The fourth lens 404 may have a negative refractive power, a first surface of the fourth lens 404 may be convex, and a second surface of the fourth lens 404 may be concave.

The fifth lens 405 may have a positive refractive power, a first surface of the fifth lens 405 may be convex, and a second surface of the fifth lens 405 may be concave.

The sixth lens 406 may have a positive refractive power, and first and second surfaces of the sixth lens 406 may be convex. The stop may be disposed at the same position on the optical axis as the first surface of the sixth lens 406, i.e., an object-side surface of the sixth lens 406.

The seventh lens 407 may have a negative refractive power, a first surface of the seventh lens 407 may be convex, and a second surface of the seventh lens 407 may be concave.

The eighth lens 408 may have a positive refractive power, and first and second surfaces of the eighth lens 408 may be convex.

The ninth lens 409 may have a negative refractive power, and first and second surfaces of the ninth lens 409 may be concave.

The tenth lens 410 may have a positive refractive power, a first surface of the tenth lens 410 may be concave, and a second surface of the tenth lens 410 may be convex.

Surfaces of each of the third lens 403 to tenth lens 410 may have aspherical coefficients as listed in Table 12 below. For example, object-side surfaces and image-side surfaces of the remaining lenses, other than the first lens 401 and the second lens 402, may be aspherical surfaces.

TABLE 12

| Value | S7 | S8 | S9 | S10 | S11 | S12 | S13 | S14 |
|---|---|---|---|---|---|---|---|---|
| Conic | −10.797 | −4.317 | 40.096 | 0.754 | −1.017 | −7.743 | −0.359 | −61.403 |
| Constant | | | | | | | | |
| (K) | | | | | | | | |
| 4th-Order | 8.642E−04 | −2.150E−04 | −3.752E−03 | 1.062E−03 | −1.366E−03 | −1.900E−03 | −4.793E−05 | 1.529E−04 |
| Coefficient | | | | | | | | |
| (A) | | | | | | | | |
| 6th-Order | 5.903E−05 | 9.937E−05 | −1.387E−06 | −2.559E−04 | −3.181E−05 | −3.411E−05 | 2.971E−05 | −2.482E−05 |
| Coefficient | | | | | | | | |
| (B) | | | | | | | | |
| 8th-Order | −5.477E−06 | −1.004E−05 | 8.895E−07 | −3.087E−05 | −1.229E−05 | 1.051E−05 | −1.457E−05 | −1.739E−05 |
| Coefficient | | | | | | | | |
| (C) | | | | | | | | |
| 10th-Order | −2.689E−07 | −5.009E−07 | −2.429E−06 | −9.779E−07 | −1.106E−07 | −1.204E−06 | 6.013E−07 | 9.899E−07 |
| Coefficient | | | | | | | | |
| (D) | | | | | | | | |
| Value | S15 | S16 | S17 | S18 | S19 | S20 | S21 | S22 |
| Conic | −10.710 | −0.653 | −0.790 | −74.965 | 46.334 | −17.420 | 30.180 | 7.607 |
| Constant | | | | | | | | |
| (K) | | | | | | | | |
| 4th-Order | −1.200E−03 | −7.130E−03 | −1.545E−04 | 1.007E−03 | −5.422E−06 | −7.590E−03 | −1.591E−02 | −9.766E−03 |
| Coefficient | | | | | | | | |
| (A) | | | | | | | | |
| 6th-Order | −5.350E−05 | 9.799E−04 | −1.088E−05 | −6.424E−04 | 1.965E−03 | 2.865E−03 | −4.652E−04 | 2.310E−04 |
| Coefficient | | | | | | | | |
| (B) | | | | | | | | |
| 8th-Order | 3.601E−05 | −5.847E−05 | −1.415E−04 | −9.663E−05 | 5.046E−04 | 4.428E−04 | 4.799E−04 | 1.342E−04 |
| Coefficient | | | | | | | | |
| (C) | | | | | | | | |
| 10th-Order | −5.408E−07 | 9.945E−06 | −9.768E−07 | 2.643E−06 | −1.520E−04 | −1.213E−04 | −3.673E−05 | −1.208E−05 |
| Coefficient | | | | | | | | |
| (D) | | | | | | | | |

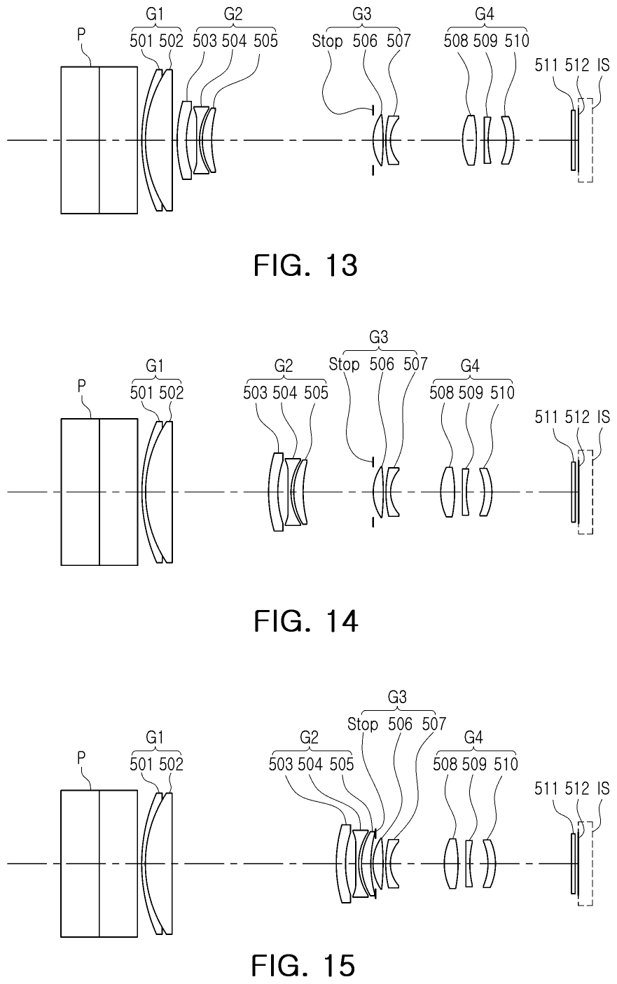

FIG. 13 is a diagram illustrating a wide-angle mode of an optical imaging system according to a fifth embodiment of the present disclosure. FIG. 14 is a diagram illustrating a normal mode of the optical imaging system of FIG. 13. FIG. 15 is a diagram illustrating a telephoto mode of the optical imaging system of FIG. 13.

The optical imaging system according to the fifth embodiment of the present disclosure will be described with reference to FIGS. 13 to 15.

The optical imaging system according to the fifth embodiment of the present disclosure may include a first lens group G1, a second lens group G2, a third lens group G3, and a fourth lens group G4. In addition, the optical imaging system may include a reflective member P disposed in front of the first lens group G1.

In sequence from an object side of the optical imaging system, the first lens group G1 may include a first lens 501 and a second lens 502, the second lens group G2 may include a third lens 503, a fourth lens 504, and a fifth lens 505, the third lens group G3 may include a stop, a sixth lens 506, and a seventh lens 507, and the fourth lens group G4 may include an eighth lens 508, a ninth lens 509, and a tenth lens 510.

In addition, the optical imaging system may further include a filter 511 and an image sensor IS.

The optical imaging system according to the fifth embodiment of the present disclosure may form a focal point on an imaging plane 512. The imaging plane 512 may refer to a surface on which a focal point is formed by the optical imaging system. As an example, the imaging plane 512 may refer to one surface of the image sensor IS receiving light.

In the fifth embodiment of the present disclosure, the reflective member P may be a prism, but alternatively may be a mirror.

At least one lens group among the first to fourth lens groups G1 to G4 may be moved to change a total focal length of the optical imaging system. As an example, the first lens group G1 and the third lens group G3 may be fixed and the second lens group G2 may be moved along an optical axis of the optical imaging system to change the total focal length of the optical imaging system may be changed. That is, as the second lens group G2 is moved away from an object side of the optical imaging system toward an image side of the optical imaging system, the total focal length of the optical imaging system may be changed from a wide-angle mode to a normal mode to a telephoto mode.

In addition, at least one lens group among the first to fourth lens groups G1 to G4 may be moved to correct a focal position according to a change in the total focal length of the optical imaging system. As an example, when the total focal length of the optical imaging system is changed from the wide-angle mode to the telephoto mode, the fourth lens group G4 may be moved along the optical axis to correct the focal position.

The characteristics of each lens (a radius of curvature, a thickness of a lens or a distance between lenses, a refractive index, and an Abbe number) are listed in Table 13 below.

TABLE 13

| | | | Thick- | Refrac- | | |
|---|---|---|---|---|---|---|
| Surface | Compo- | Radius of | ness or | tive | Abbe | Lens |
| No. | nent | Curvature | Distance | Index | Number | Group |
| Object | | | D0 | | | |
| S1 | Prism | Infinity | 3.55 | 1.5168 | 64.2 | |
| S2 | | Infinity | 3.55 | 1.5168 | 64.2 | |
| S3 | | Infinity | 0.5 | | | |
| S4 | First | 16.584 | 0.23 | 1.95375 | 32.32 | First |
| | Lens | | | | | Lens |
| S5 | Second | 11.556 | 2.51 | 1.618 | 63.4 | Group |
| S6 | Lens | Infinity | D1 | | | |
| S7 | Third | 21.971 | 0.81 | 1.535 | 55.73 | Second |
| S8 | Lens | 7.769 | 1.1 | | | Lens |
| S9 | Fourth | 524.92 | 0.13 | 1.535 | 55.73 | Group |
| S10 | Lens | 5.001 | 0.194 | | | |
| S11 | Fifth | 4.243 | 0.89 | 1.6355 | 23.89 | |
| S12 | Lens | 6.215 | D2 | | | |
| | Stop | Infinity | 0 | | | Third |
| S13 | Sixth | 3.934 | 0.87 | 1.535 | 55.73 | Lens |
| S14 | Lens | −48.367 | 0.283 | | | Group |
| S15 | Seventh | 5.83 | 0.45 | 1.6355 | 23.89 | |
| | Lens | | | | | |
| S16 | | 2.877 | D3 | | | |
| S17 | Eighth | 4.69 | 1.16 | 1.535 | 55.73 | Fourth |
| | Lens | | | | | Lens |
| S18 | | −67.094 | 0.861 | | | Group |
| S19 | Ninth | −16.448 | 0.33 | 1.535 | 55.73 | |
| | Lens | | | | | |
| S20 | | 9.336 | 1.629 | | | |
| S21 | Tenth | −12.539 | 0.66 | 1.6355 | 23.89 | |
| S22 | Lens | −10.726 | D4 | | | |
| S23 | Filter | Infinity | 0.21 | 1.5168 | 64.2 | |
| S24 | | Infinity | D5 | | | |
| S25 | Imaging | Infinity | | | | |
| | Plane | | | | | |

TABLE 14

| Object at Infinity | | | | Object at Near Focus Position | | | |
|---|---|---|---|---|---|---|---|
| | Wide-Angle | Normal | Telephoto | | Wide-Angle | Normal | Telephoto |
| Value | Mode | Mode | Mode | Value | Mode | Mode | Mode |
| D0 | Infinity | Infinity | Infinity | DC | 600 | 600 | 600 |
| D1 | 0.49426 | 8.81592 | 15.09397 | D1 | 0.49426 | 8.81592 | 15.09397 |
| D2 | 14.92959 | 6.60793 | 0.32988 | D2 | 14.92959 | 6.60793 | 0.32988 |
| D3 | 6.701622 | 4.608341 | 5.014959 | D3 | 6.570027 | 4.060178 | 3.051292 |
| D4 | 5.707528 | 7.800809 | 7.394191 | D4 | 5.839123 | 8.348972 | 9.357858 |
| D5 | 0.1 | 0.1 | 0.1 | D5 | 0.1 | 0.1 | 0.1 |
| f | 8.3815 | 17.9463 | 33.5279 | MAG | 0.0136 | 0.0288 | 0.0558 |
| HFOV | 17.612 | 8.086 | 4.331 | HFOV | 17.555 | 7.919 | 4.006 |
| Fno | 3.385 | 3.618 | 3.549 | Fno | 3.396 | 3.7 | 3.863 |
| L | 47.85 | 47.85 | 47.85 | L | 47.85 | 47.85 | 47.85 |

In Table 14 above, DO may be an object distance, i.e., a distance on the optical axis between an object and a first surface of the reflective member P, D1 may be a distance on the optical axis between the second lens 502 and the third lens 503, D2 may be a distance on the optical axis between the fifth lens 505 and the stop, D3 may be a distance on the optical axis between the seventh lens 507 and the eighth lens 508, D4 may be a distance on the optical axis between the tenth lens 510 and the filter 511, and D5 may be a distance on the optical axis between the filter 511 and the imaging plane 512.

f may be a total focal length of the optical imaging system, MAG may be a magnification of the optical imaging system, HFOV may be one half of a field of view of the optical imaging system, Fno may be a F-number of the optical imaging system, and L may be a distance on the optical axis from a first surface of the reflective member P to the imaging plane 512.

The values in Table 14 above are listed for the wide-angle, normal, and telephoto modes for both an object at infinity and an object at a near focus position of the optical imaging system, i.e., a closest position of the object at which the optical imaging system can focus an image of the object.

A focal length fG1 of the first lens group G1 may be 34.9006 mm, a focal length fG2 of the second lens group G2 may be −9.7502 mm, a focal length fG3 of the third lens group G3 may be 16.0521 mm, and a focal length fG4 of the fourth lens group G4 may be 17.9994 mm.

A focal length of the first lens 501 may be −40.877 mm, a focal length of the second lens 502 may be 18.701 mm, a focal length of the third lens 503 may be −22.921 mm, a focal length of the fourth lens 504 may be −9.438 mm, a focal length of the fifth lens 505 may be 17.903 mm, a focal length of the sixth lens 506 may be 6.840 mm, a focal length of the seventh lens 507 may be −9.500 mm, a focal length of the eighth lens 508 may be 8.240 mm, a focal length of the ninth lens 509 may be −11.082 mm, and a focal length of the tenth lens 510 may be 102.155 mm.

Among the third to tenth lenses 503 to 510, the third lens 503 may have a largest effective radius.

An effective radius of the third lens 503 may be 3.25 mm, and a radius of the stop may be 2.35 mm.

An entrance pupil diameter EPDw of the optical imaging system in the wide-angle mode may be 2.470 mm, and an entrance pupil diameter EPDt of the optical imaging system in the telephoto mode may be 9.43 mm.

In the fifth embodiment of the present disclosure, the first lens group G1 may generally have a positive refractive power, the second lens group G2 may generally have a negative refractive power, the third lens group G3 may generally have a positive refractive power, and the fourth lens group G4 may generally have a positive refractive power.

The first lens 501 may have a negative refractive power, a first surface of the first lens 501 may be convex, and a second surface of the first lens 501 may be concave.

The second lens 502 may have a positive refractive power, a first surface of the second lens 502 may be convex, and a second surface of the second lens 502 may be flat.

The first lens 501 and the second lens 502 may be bonded lenses bonded to each other.

The third lens 503 may have a negative refractive power, a first surface of the third lens 503 may be convex, and a second surface of the third lens 503 may be concave.

The fourth lens 504 may have a negative refractive power, a first surface of the fourth lens 504 may be convex, and a second surface of the fourth lens 504 may be concave.

The fifth lens 505 may have a positive refractive power, a first surface of the fifth lens 505 may be convex, and a second surface of the fifth lens 505 may be concave.

The sixth lens 506 may have a positive refractive power, and first and second surfaces of the sixth lens 506 may be convex. The stop may be disposed at the same position on the optical axis as the first surface of the sixth lens 506, i.e., an object-side surface of the sixth lens 506.

The seventh lens 507 may have a negative refractive power, a first surface of the seventh lens 507 may be convex, and a second surface of the seventh lens 507 may be concave.

The eighth lens 508 may have a positive refractive power, and first and second surfaces of the eighth lens 508 may be convex.

The ninth lens 509 may have a negative refractive power, and first and second surfaces of the ninth lens 509 may be concave.

The tenth lens 510 may have a positive refractive power, a first surface of the tenth lens 510 may be concave, and a second surface of the tenth lens 510 may be convex.

Surfaces of each of the third lens 503 to tenth lens 510 may have aspherical coefficients as listed in Table 15 below. For example, object-side surfaces and image-side surfaces of the remaining lenses, other than the first lens 501 and the second lens 502, may be aspherical surfaces.

TABLE 15

| Value | S7 | S8 | S9 | S10 | S11 | S12 | S13 | S14 |
|---|---|---|---|---|---|---|---|---|
| Conic | −12.321 | −4.257 | 36.182 | 0.745 | −1.011 | −7.844 | −0.356 | −59.557 |
| Constant | | | | | | | | |
| (K) | | | | | | | | |
| 4th-Order | 8.481E−04 | −1.974E−04 | −3.763E−03 | 1.060E−03 | −1.357E−03 | −1.913E−03 | −4.061E−05 | 1.504E−04 |
| Coefficient | | | | | | | | |
| (A) | | | | | | | | |
| 6th-Order | 5.702E−05 | 1.017E−04 | −2.206E−06 | −2.549E−04 | −3.238E−05 | −3.423E−05 | 3.106E−05 | −2.524E−05 |
| Coefficient | | | | | | | | |
| (B) | | | | | | | | |
| 8th-Order | −5.599E−06 | −9.916E−06 | 8.978E−07 | −3.095E−05 | −1.230E−05 | 1.040E−05 | −1.439E−05 | −1.754E−05 |
| Coefficient | | | | | | | | |
| (C) | | | | | | | | |
| 10th-Order | −2.835E−07 | −4.921E−07 | −2.421E−06 | −1.026E−06 | −8.694E−08 | −1.251E−06 | 6.578E−07 | 9.236E−07 |
| Coefficient | | | | | | | | |
| (D) | | | | | | | | |
| Value | S15 | S16 | S17 | S18 | S19 | S20 | S21 | S22 |
| Conic | −10.727 | −0.652 | −0.785 | −75.123 | 46.258 | −17.817 | 30.287 | 7.961 |
| Constant | | | | | | | | |
| (K) | | | | | | | | |
| 4th-Order | −1.194E−03 | −7.121E−03 | −1.480E−04 | 9.976E−04 | −8.898E−06 | −7.588E−03 | −1.581E−02 | −9.872E−03 |
| Coefficient | | | | | | | | |
| (A) | | | | | | | | |
| 6th-Order | −5.135E−05 | 9.790E−04 | −8.734E−06 | −6.449E−04 | 1.961E−03 | 2.873E−03 | −4.617E−04 | 2.242E−04 |
| Coefficient | | | | | | | | |
| (B) | | | | | | | | |
| 8th-Order | 3.655E−05 | −5.867E−05 | −1.408E−04 | −9.745E−05 | 5.043E−04 | 4.444E−04 | 4.805E−04 | 1.332E−04 |
| Coefficient | | | | | | | | |
| (C) | | | | | | | | |
| 10th-Order | −3.394E−07 | 9.695E−06 | −7.825E−07 | 2.423E−06 | −1.519E−04 | −1.211E−04 | −3.652E−05 | −1.225E−05 |
| Coefficient | | | | | | | | |
| (D) | | | | | | | | |

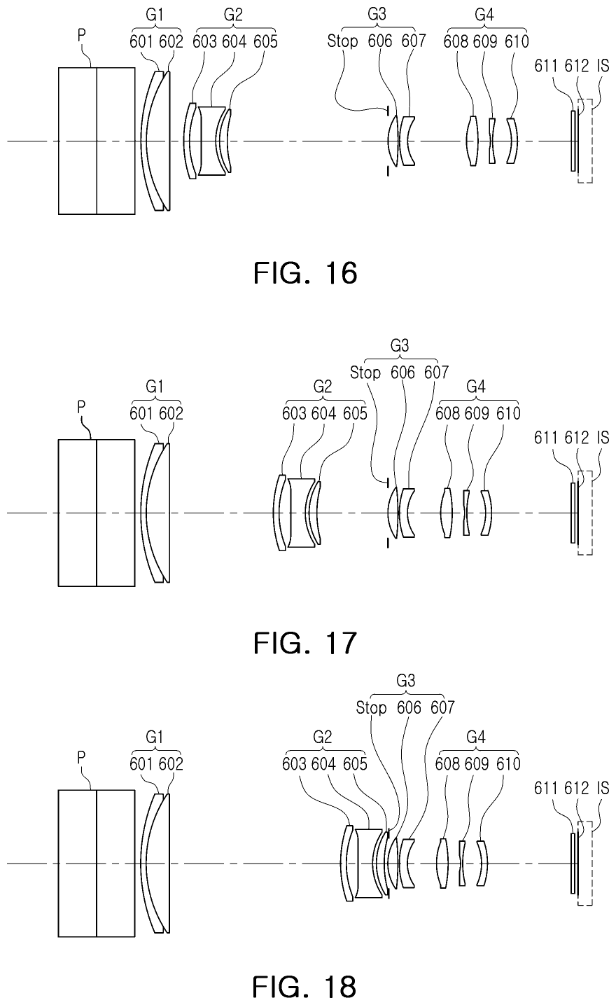

FIG. 16 is a diagram illustrating a wide-angle mode of an optical imaging system according to a sixth embodiment of the present disclosure. FIG. 17 is a diagram illustrating a normal mode of the optical imaging system of FIG. 16. according to a sixth embodiment of the present disclosure. FIG. 18 is a diagram illustrating a telephoto mode of the optical imaging system of FIG. 16.

The optical imaging system according to the sixth embodiment of the present disclosure will be described with reference to FIGS. 16 to 18.

The optical imaging system according to the sixth embodiment of the present disclosure may include a first lens group G1, a second lens group G2, a third lens group G3, and a fourth lens group G4. In addition, the optical imaging system may include a reflective member P disposed in front of the first lens group G1.

In sequence from an object side of the optical imaging system, the first lens group G1 may include a first lens 601 and a second lens 602, the second lens group G2 may include a third lens 603, a fourth lens 604, and a fifth lens 605, the third lens group G3 may include a stop, a sixth lens 606, and a seventh lens 607, and the fourth lens group G4 may include an eighth lens 608, a ninth lens 609, and a tenth lens 610.

In addition, the optical imaging system may further include a filter 611 and an image sensor IS.

The optical imaging system according to the sixth embodiment of the present disclosure may form a focal point on an imaging plane 612. The imaging plane 612 may refer to a surface on which a focal point is formed by the optical imaging system. As an example, the imaging plane 612 may refer to one surface of the image sensor IS receiving light.

In the sixth embodiment of the present disclosure, the reflective member P may be a prism, but alternatively may be a mirror.

At least one lens group among the first to fourth lens groups G1 to G4 may be moved to change a total focal length of the optical imaging system. As an example, the first lens group G1 and the third lens group G3 may be fixed and the second lens group G2 may be moved along an optical axis of the optical imaging system to change the total focal length of the optical imaging system may be changed. That is, as the second lens group G2 is moved away from an object side of the optical imaging system toward an image side of the optical imaging system, the total focal length of the optical imaging system may be changed from a wide-angle mode to a normal mode to a telephoto mode.

In addition, at least one lens group among the first to fourth lens groups G1 to G4 may be moved to correct a focal position according to a change in the total focal length of the optical imaging system. As an example, when the total focal length of the optical imaging system is changed from the wide-angle mode to the telephoto mode, the fourth lens group G4 may be moved along the optical axis to correct the focal position.

The characteristics of each lens (a radius of curvature, a thickness of a lens or a distance between lenses, a refractive index, and an Abbe number) are listed in Table 16 below.

TABLE 16

| | | | Thick- | Refrac- | | |
|---|---|---|---|---|---|---|
| Surface | Compo- | Radius of | ness or | tive | Abbe | Lens |
| No. | nent | Curvature | Distance | Index | Number | Group |
| Object | | | D0 | | | |
| S1 | Prism | Infinity | 3.55 | 1.5168 | 64.2 | |
| S2 | | Infinity | 3.55 | 1.5168 | 64.2 | |
| S3 | | Infinity | 0.5 | | | |
| S4 | First | 16.851 | 0.45 | 1.95375 | 32.32 | First |
| | Lens | | | | | Lens |
| S5 | Second | 11.276 | 2.3 | 1.618 | 63.4 | Group |
| S6 | Lens | Infinity | D1 | | | |
| S7 | Third | 21.766 | 0.45 | 1.535 | 55.73 | Second |
| S8 | Lens | 6.36 | 1.117 | | | Lens |
| S9 | Fourth | 32.517 | 1.31 | 1.535 | 55.73 | Group |
| S10 | Lens | 4.979 | 0.337 | | | |
| S11 | Fifth | 4.265 | 0.71 | 1.6355 | 23.89 | |
| S12 | Lens | 6.404 | D2 | | | |
| | Stop | Infinity | 0 | | | Third |
| S13 | Sixth | 3.908 | 0.92 | 1.535 | 55.73 | Lens |
| S14 | Lens | −48.473 | 0.157 | | | Group |
| S15 | Seventh | 6.001 | 0.74 | 1.6355 | 23.89 | |
| S16 | Lens | 2.833 | D3 | | | |
| S17 | Eighth | 5.459 | 1.06 | 1.535 | 55.73 | Fourth |
| S18 | Lens | −22.312 | 1.109 | | | Lens |
| S19 | Ninth | −16.518 | 0.24 | 1.535 | 55.73 | Group |
| S20 | Lens | 9.331 | 1.723 | | | |
| S21 | Tenth | −12.573 | 0.57 | 1.6355 | 23.89 | |
| S22 | Lens | −12.828 | D4 | | | |
| S23 | Filter | Infinity | 0.21 | 1.5168 | 64.2 | |
| S24 | | Infinity | D5 | | | |
| S25 | Imaging | Infinity | | | | |
| | Plane | | | | | |

TABLE 17

| Object at Infinity | | | | Object at Near Focus Position | | | |
|---|---|---|---|---|---|---|---|
| | Wide-Angle | Normal | Telephoto | | Wide-Angle | Normal | Telephoto |
| Value | Mode | Mode | Mode | Value | Mode | Mode | Mode |
| D0 | Infinity | Infinity | Infinity | D0 | 600 | 600 | 600 |
| D1 | 1.2594 | 9.5443 | 15.7271 | D1 | 1.2594 | 9.5443 | 15.7271 |
| D2 | 14.8501 | 6.5652 | 0.3824 | D2 | 14.8501 | 6.5652 | 0.3824 |
| D3 | 5.4314 | 3.0825 | 2.7121 | D3 | 5.2921 | 2.5152 | 0.6862 |
| D4 | 5.2833 | 7.6322 | 8.0026 | D4 | 5.4226 | 8.1995 | 10.0285 |
| D5 | 0.1 | 0.1 | 0.1 | D5 | 0.1 | 0.1 | 0.1 |
| f | 8.4044 | 17.9343 | 33.5882 | MAG | 0.0136 | 0.0288 | 0.0569 |
| HFOV | 15.743 | 7.808 | 4.231 | HFOV | 15.695 | 7.646 | 3.8773 |
| Fno | 3.418 | 3.746 | 3.818 | Fno | 3.435 | 3.762 | 4.14 |
| L | 47.9272 | 47.9272 | 47.9272 | L | 47.9272 | 47.9272 | 47.9272 |

In Table 17 above, DO may be an object distance, i.e., a distance on the optical axis between an object and a first surface of the reflective member P, D1 may be a distance on the optical axis between the second lens 602 and the third lens 603, D2 may be a distance on the optical axis between the fifth lens 605 and the stop, D3 may be a distance on the optical axis between the seventh lens 607 and the eighth lens 608, D4 may be a distance on the optical axis between the tenth lens 610 and the filter 611, and D5 may be a distance on the optical axis between the filter 611 and the imaging plane 612.

f may be a total focal length of the optical imaging system, MAG may be a magnification of the optical imaging system, HFOV may be one half of field of view of the optical imaging system, Fno may be a F-number of the optical imaging system, and L may be a distance on the optical axis from a first surface of the reflective member P to the imaging plane 612.

The values in Table 17 above are listed for the wide-angle, normal, and telephoto modes for both an object at infinity and an object at a near focus position of the optical imaging system, i.e., a closest position of the object at which the optical imaging system can focus an image of the object.

A focal length fG1 of the first lens group G1 may be 36.7491 mm, a focal length fG2 of the second lens group G2 may be −9.8578 mm, a focal length fG3 of the third lens group G3 may be 15.2439 mm, and a focal length fG4 of the fourth lens group G4 may be 20.5837 mm.

A focal length of the first lens 601 may be −37.201 mm, a focal length of the second lens 602 may be 18.248 mm, a focal length of the third lens 603 may be −16.968 mm, a focal length of the fourth lens 604 may be −11.174 mm, a focal length of the fifth lens 605 may be 17.797 mm, a focal length of the sixth lens 606 may be 6.801 mm, a focal length of the seventh lens 607 may be −9.287 mm, a focal length of the eighth lens 608 may be 8.309 mm, a focal length of the ninth lens 609 may be −11.109 mm, and a focal length of the tenth lens 610 may be −7572.053 mm.

Among the third to tenth lenses 603 to 610, the third lens 603 may have a largest effective radius.

An effective radius of the third lens 603 may be 3.25 mm, and a radius of the stop may be 2.35 mm.

An entrance pupil diameter EPDw of the optical imaging system in the wide-angle mode may be 2.458 mm, and an entrance pupil diameter EPDt of the optical imaging system in the telephoto mode may be 8.81 mm.

In the sixth embodiment of the present disclosure, the first lens group G1 may generally have a positive refractive power, the second lens group G2 may generally have a negative refractive power, the third lens group G3 may generally have a positive refractive power, and the fourth lens group G4 may generally have a positive refractive power.

The first lens 601 may have a negative refractive power, a first surface of the first lens 601 may be convex, and a second surface of the first lens 601 may be concave.

The second lens 602 may have a positive refractive power, a first surface of the second lens 602 may be convex, and a second surface of the second lens 602 may be flat.

The first lens 601 and the second lens 602 may be bonded lenses bonded to each other.

The third lens 603 may have a negative refractive power, a first surface of the third lens 603 may be convex, and a second surface of the third lens 603 may be concave.

The fourth lens 604 may have a negative refractive power, a first surface of the fourth lens 604 may be convex, and a second surface of the fourth lens 604 may be concave.

The fifth lens 605 may have a positive refractive power, a first surface of the fifth lens 605 may be convex, and a second surface of the fifth lens 605 may be concave.

The sixth lens 606 may have a positive refractive power, and first and second surfaces of the sixth lens 606 may be convex. The stop may be disposed at the same position on the optical axis as the first surface of the sixth lens 606, i.e., an object-side surface of the sixth lens 606.

The seventh lens 607 may have a negative refractive power, a first surface of the seventh lens 607 may be convex, and a second surface of the seventh lens 607 may be concave.

The eighth lens 608 may have a positive refractive power, and first and second surfaces of the eighth lens 608 may be convex.

The ninth lens 609 may have a negative refractive power, and first and second surfaces of the ninth lens 609 may be concave.

The tenth lens 610 may have a negative refractive power, a first surface of the tenth lens 610 may be concave, and a second surface of the tenth lens 610 may be convex.

Surfaces of each of the third lens 603 to tenth lens 610 may have aspherical coefficients as listed in Table 18 below. For example, object-side surfaces and image-side surfaces of the remaining lenses, other than the first lens 601 and the second lens 602, may be aspherical surfaces.

TABLE 18

| Value | S7 | S8 | S9 | S10 | S11 | S12 | S13 | S14 |
|---|---|---|---|---|---|---|---|---|
| Conic Constant (K) | −9.947 | −4.268 | −72.083 | 0.746 | −1.028 | −7.896 | −0.361 | −55.936 |
| 4th-Order Coefficient (A) | 8.801E−04 | −2.073E−04 | −3.737E−03 | 1.062E−03 | −1.384E−03 | −1.894E−03 | −3.938E−05 | 1.500E−04 |
| 6th-Order Coefficient (B) | 6.423E−05 | 9.832E−05 | −2.093E−07 | −2.541E−04 | −3.712E−05 | −2.930E−05 | 2.398E−05 | −2.036E−05 |
| 8th-Order Coefficient (C) | −5.070E−06 | −1.022E−05 | 1.053E−06 | −3.118E−05 | −1.256E−05 | 1.078E−05 | −1.521E−05 | −1.690E−05 |
| 10th-Order Coefficient (D) | −2.574E−07 | −5.068E−07 | −2.416E−06 | −1.052E−06 | −1.023E−07 | −1.221E−06 | 5.762E−07 | 1.016E−06 |
| Value | S15 | S16 | S17 | S18 | S19 | S20 | S21 | S22 |
| Conic Constant (K) | −10.191 | −0.667 | −0.824 | −80.000 | 46.034 | −17.757 | 30.302 | 7.255 |
| 4th-Order Coefficient (A) | −1.169E−03 | −7.257E−03 | −1.810E−04 | 1.035E−03 | −1.167E−06 | −7.613E−03 | −1.589E−02 | −9.749E−03 |
| 6th-Order Coefficient (B) | −5.933E−05 | 9.840E−04 | −2.230E−05 | −6.398E−04 | 1.968E−03 | 2.857E−03 | −4.470E−04 | 2.282E−04 |
| 8th-Order Coefficient (C) | 3.530E−05 | −5.828E−05 | −1.425E−04 | −9.723E−05 | 5.063E−04 | 4.395E−04 | 4.814E−04 | 1.359E−04 |
| 10th-Order Coefficient (D) | −4.997E−07 | 9.175E−06 | −9.380E−07 | 2.397E−06 | −1.515E−04 | −1.223E−04 | −3.711E−05 | −1.128E−05 |

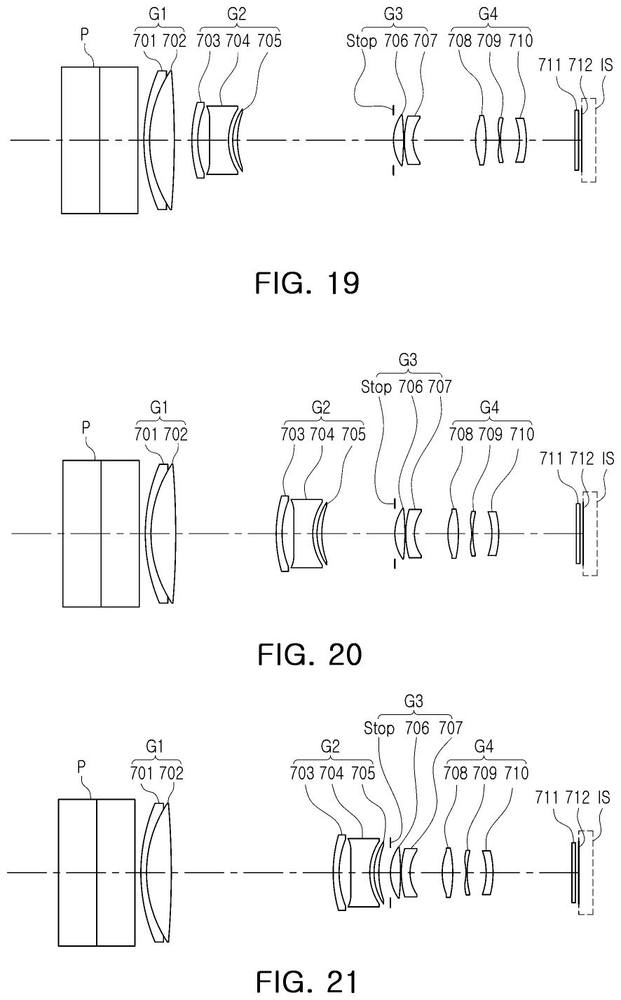

FIG. 19 is a diagram illustrating a wide-angle mode of an optical imaging system according to a seventh embodiment of the present disclosure. FIG. 20 is a diagram illustrating a normal mode of the optical imaging system of FIG. 19. FIG. 21 is a diagram illustrating a telephoto mode of the optical imaging system of FIG. 19.

The optical imaging system according to the seventh embodiment of the present disclosure will be described with reference to FIGS. 19 to 21.

The optical imaging system according to the seventh embodiment of the present disclosure may include a first lens group G1, a second lens group G2, a third lens group G3, and a fourth lens group G4. In addition, the optical imaging system may include a reflective member P disposed in front of the first lens group G1.

In sequence from an object side of the optical imaging system, the first lens group G1 may include a first lens 701 and a second lens 702, the second lens group G2 may include a third lens 703, a fourth lens 704, and a fifth lens 705, the third lens group G3 may include a stop, a sixth lens 706, and a seventh lens 707, and the fourth lens group G4 may include an eighth lens 708, a ninth lens 709, and a tenth lens 710.

In addition, the optical imaging system may further include a filter 711 and an image sensor IS.

The optical imaging system according to the seventh embodiment of the present disclosure may form a focal point on an imaging plane 712. The imaging plane 712 may refer to a surface on which a focal point is formed by the optical imaging system. As an example, the imaging plane 712 may refer to one surface of the image sensor IS receiving light.

In the seventh embodiment of the present disclosure, the reflective member P may be a prism, but alternatively may be a mirror.

At least one lens group among the first to fourth lens groups G1 to G4 may be moved to change a total focal length of the optical imaging system. As an example, the first lens group G1 and the third lens group G3 may be fixed and the second lens group G2 may be moved along an optical axis of the optical imaging system to change the total focal length of the optical imaging system may be changed. That is, as the second lens group G2 is moved away from an object side of the optical imaging system toward an image side of the optical imaging system, the total focal length of the optical imaging system may be changed from a wide-angle mode to a normal mode to a telephoto mode.

In addition, at least one lens group among the first to fourth lens groups G1 to G4 may be moved to correct a focal position according to a change in the total focal length of the optical imaging system. As an example, when the total focal length of the optical imaging system is changed from the wide-angle mode to the telephoto mode, the fourth lens group G4 may be moved along the optical axis to correct the focal position.

The characteristics of each lens (a radius of curvature, a thickness of a lens or a distance between lenses, a refractive index, and an Abbe number) are listed in Table 19 below.

TABLE 19

| Surface | | Radius of | Thickness or | Refractive | Abbe | Lens |
|---|---|---|---|---|---|---|
| No. | Component | Curvature | Distance | Index | Number | Group |
| Object | | | D0 | | | |
| S1 | Prism | Infinity | 3.55 | 1.5168 | 64.2 | |
| S2 | | Infinity | 3.55 | 1.5168 | 64.2 | |
| S3 | | Infinity | 0.5 | | | |
| S4 | First Lens | 17.795 | 0.45 | 1.95375 | 32.32 | First |
| S5 | Second | 10.949 | 2.3 | 1.618 | 63.4 | Lens |
| S6 | Lens | −95.949 | D1 | | | Group |
| S7 | Third | 24.857 | 0.55 | 1.535 | 55.73 | Second |
| S8 | Lens | 6.108 | 1.121 | | | Lens |
| S9 | Fourth | 26.771 | 1.72 | 1.535 | 55.73 | Group |
| S10 | Lens | 5.006 | 0.415 | | | |
| S11 | Fifth | 4.334 | 0.47 | 1.6355 | 23.89 | |
| S12 | Lens | 6.238 | D2 | | | |
| | Stop | Infinity | 0 | | | Third |
| S13 | Sixth | 3.902 | 0.83 | 1.535 | 55.73 | Lens |
| S14 | Lens | −50.358 | 0.1 | | | Group |
| S15 | Seventh | 6.058 | 0.81 | 1.6355 | 23.89 | |
| S16 | Lens | 2.941 | D3 | | | |
| S17 | Eighth | 5.64 | 0.88 | 1.535 | 55.73 | Fourth |
| S18 | Lens | −20.228 | 1.238 | | | Lens |
| S19 | Ninth | −16.854 | 0.1 | 1.535 | 55.73 | Group |
| S20 | Lens | 9.056 | 1.795 | | | |
| S21 | Tenth | −13.01 | 0.62 | 1.6355 | 23.89 | |
| S22 | Lens | −17.785 | D4 | | | |
| S23 | Filter | Infinity | 0.21 | 1.5168 | 64.2 | |
| S24 | | Infinity | D5 | | | |
| S25 | Imaging Plane | Infinity | | | | |

TABLE 20

| Object at Infinity | | | | Object at Near Focus Position | | | |
|---|---|---|---|---|---|---|---|
| | Wide-Angle | Normal | Telephoto | | Wide-Angle | Normal | Telephoto |
| Value | Mode | Mode | Mode | Value | Mode | Mode | Mode |
| D0 | Infinity | Infinity | Infinity | D0 | 600 | 600 | 600 |
| D1 | 1.6292 | 9.2847 | 14.9432 | D1 | 1.6292 | 9.2847 | 14.9432 |
| D2 | 14.3679 | 6.7124 | 1.0539 | D2 | 14.3679 | 6.7124 | 1.0539 |
| D3 | 5.798027 | 3.174065 | 3.024286 | D3 | 5.644356 | 2.551462 | 0.86138 |
| D4 | 4.751873 | 7.375835 | 7.525614 | D4 | 4.905544 | 7.998438 | 9.68852 |
| D5 | 0.1 | 0.1 | 0.1 | D5 | 0.1 | 0.1 | 0.1 |
| f | 8.4049 | 18.0683 | 33.471 | MAG | 0.0136 | 0.0291 | 0.0563 |
| HFOV | 15.47 | 7.619 | 4.202 | HFOV | 15.423 | 7.466 | 3.874 |
| Fno | 3.492 | 3.851 | 3.868 | Fno | 3.511 | 3.963 | 4.295 |
| L | 47.856 | 47.856 | 47.856 | L | 47.856 | 47.856 | 47.856 |

In Table 20 above, DO may be an object distance, i.e., a distance on the optical axis between an object and a first surface of the reflective member P, D1 may be a distance on the optical axis between the second lens 702 and the third lens 703, D2 may be a distance on the optical axis between the fifth lens 705 and the stop, D3 may be a distance on the optical axis between the seventh lens 707 and the eighth lens 708, D4 may be a distance on the optical axis between the tenth lens 710 and the filter 711, and D5 may be a distance on the optical axis between the filter 711 and the imaging plane 712.

f may be a total focal length of the optical imaging system, MAG may be a magnification of the optical imaging system, HFOV may be one half of a field of view of the optical imaging system, Fno may be a F-number of the optical imaging system, and L may be a distance on the optical axis from a first surface of the reflective member P to the imaging plane 712.

The values in Table 20 above are listed for the wide-angle, normal, and telephoto modes for both an object at infinity and an object at a near focus position of the optical imaging system, i.e., a closest position of the object at which the optical imaging system can focus an image of the object.

A focal length fG1 of the first lens group G1 may be 33.9465 mm, a focal length fG2 of the second lens group G2 may be −9.0888 mm, a focal length fG3 of the third lens group G3 may be 13.9672 mm, and a focal length fG4 of the fourth lens group G4 may be 26.0426 mm.

A focal length of the first lens 701 may be −30.829 mm, a focal length of the second lens 702 may be 16.034 mm, a focal length of the third lens 703 may be −15.293 mm, a focal length of the fourth lens 704 may be −11.835 mm, a focal length of the fifth lens 705 may be 20.388 mm, a focal length of the sixth lens 706 may be 6.805 mm, a focal length of the seventh lens 707 may be −10.005 mm, a focal length of the eighth lens 708 may be 8.342 mm, a focal length of the ninth lens 709 may be −10.996 mm, and a focal length of the tenth lens 710 may be −80.302 mm.

Among the third to tenth lenses 703 to 710, the third lens 703 may have a largest effective radius.

An effective radius of the third lens 703 may be 3.25 mm, and a radius of the stop may be 2.35 mm.

An entrance pupil diameter EPDw of the optical imaging system in the wide-angle mode may be 2.403 mm, and an entrance pupil diameter EPDt of the optical imaging system in the telephoto mode may be 8.65 mm.

In the seventh embodiment of the present disclosure, the first lens group G1 may generally have a positive refractive power, the second lens group G2 may generally have a negative refractive power, the third lens group G3 may generally have a positive refractive power, and the fourth lens group G4 may generally have a positive refractive power.

The first lens 701 may have a negative refractive power, a first surface of the first lens 701 may be convex, and a second surface of the first lens 701 may be concave.

The second lens 702 may have a positive refractive power, first and second surfaces of the second lens 702 may be convex.

The first lens 701 and the second lens 702 may be bonded lenses bonded to each other.

The third lens 703 may have a negative refractive power, a first surface of the third lens 703 may be convex, and a second surface of the third lens 703 may be concave.

The fourth lens 704 may have a negative refractive power, a first surface of the fourth lens 704 may be convex, and a second surface of the fourth lens 704 may be concave.

The fifth lens 705 may have a positive refractive power, a first surface of the fifth lens 705 may be convex, and a second surface of the fifth lens 705 may be concave.

The sixth lens 706 may have a positive refractive power, and first and second surfaces of the sixth lens 706 may be convex. The stop may be disposed at the same position on the optical axis as the first surface of the sixth lens 706, i.e., an object-side of the seventh lens 706.

The seventh lens 707 may have a negative refractive power, a first surface of the seventh lens 707 may be convex, and a second surface of the seventh lens 707 may be concave.

The eighth lens 708 may have a positive refractive power, and first and second surfaces of the eighth lens 708 may be convex.

The ninth lens 709 may have a negative refractive power, and first and second surfaces of the ninth lens 709 may be concave.

The tenth lens 710 may have a negative refractive power, a first surface of the tenth lens 710 may be concave, and a second surface of the tenth lens 710 may be convex.

Surfaces of each of the third lens 703 to tenth lens 710 may have aspherical coefficients as listed in Table 21 below. For example, object-side surfaces and image-side surfaces of the remaining lenses, other than the first lens 701 and the second lens 702, may be aspherical surfaces.

TABLE 21

| Value | S7 | S8 | S9 | S10 | S11 | S12 | S13 | S14 |
|---|---|---|---|---|---|---|---|---|
| Conic Constant (K) | −16.018 | −3.990 | −80.000 | 0.749 | −1.058 | −7.513 | −0.362 | −79.998 |
| 4th-Order Coefficient (A) | 8.426E−04 | −1.934E−04 | −3.723E−03 | 1.099E−03 | −1.431E−03 | −1.838E−03 | −3.228E−05 | 1.711E−04 |
| 6th-Order Coefficient (B) | 6.380E−05 | 9.311E−05 | 6.494E−06 | −2.620E−04 | −3.478E−05 | −3.001E−05 | 1.907E−05 | −1.366E−05 |
| 8th-Order Coefficient (C) | −5.346E−06 | −1.051E−05 | 1.540E−06 | −3.235E−05 | −1.191E−05 | 1.038E−05 | −1.622E−05 | −1.586E−05 |
| 10th-Order Coefficient (D) | −2.927E−07 | −5.116E−07 | −2.400E−06 | −1.063E−06 | −9.520E−08 | −1.206E−06 | 4.371E−07 | 1.129E−06 |
| Value | S15 | S16 | S17 | S18 | S19 | S20 | S21 | S22 |
| Conic Constant (K) | −9.922 | −0.684 | −0.849 | −76.088 | 45.943 | −16.396 | 30.106 | 1.524 |
| 4th-Order Coefficient (A) | −1.148E−03 | −7.356E−03 | −1.998E−04 | 1.077E−03 | −2.990E−05 | −7.532E−03 | −1.585E−02 | −9.641E−03 |
| 6th-OrderCoefficient (B) | −6.122E−05 | 9.684E−04 | −3.884E−05 | −6.292E−04 | 1.982E−03 | 2.851E−03 | −4.241E−04 | 2.704E−04 |
| 8th-Order Coefficient (C) | 3.483E−05 | −6.243E−05 | −1.448E−04 | −9.609E−05 | 5.137E−04 | 4.312E−04 | 4.844E−04 | 1.508E−04 |
| 10th-Order Coefficient (D) | −5.153E−07 | 7.735E−06 | −1.339E−06 | 2.628E−06 | −1.498E−04 | −1.251E−04 | −3.521E−05 | −7.826E−06 |

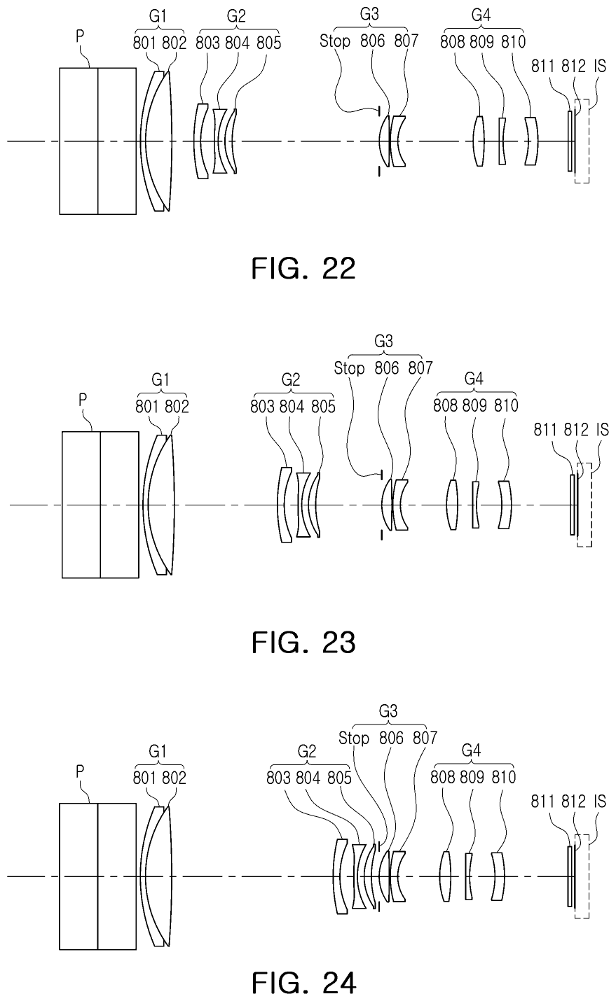

FIG. 22 is a diagram illustrating a wide-angle mode of an optical imaging system according to an eighth embodiment of the present disclosure. FIG. 23 is a diagram illustrating a normal mode of the optical imaging system of FIG. 22. FIG. 24 is a diagram illustrating a telephoto mode of the optical imaging system of FIG. 22.

The optical imaging system according to the eighth embodiment of the present disclosure will be described with reference to FIGS. 22 to 24.

The optical imaging system according to the eighth embodiment of the present disclosure may include a first lens group G1, a second lens group G2, a third lens group G3, and a fourth lens group G4. In addition, the optical imaging system may include a reflective member P disposed in front of the first lens group G1.

In sequence from an object side of the optical imaging system, the first lens group G1 may include a first lens 801 and a second lens 802, the second lens group G2 may include a third lens 803, a fourth lens 804, and a fifth lens 805, the third lens group G3 may include a stop, a sixth lens 806, and a seventh lens 807, and the fourth lens group G4 may include an eighth lens 808, a ninth lens 809, and a tenth lens 810.

In addition, the optical imaging system may further include a filter 811 and an image sensor IS.

The optical imaging system according to the eighth embodiment of the present disclosure may form a focal point on an imaging plane 812. The imaging plane 812 may refer to a surface on which a focal point is formed by the optical imaging system. As an example, the imaging plane 812 may refer to one surface of the image sensor IS receiving light.

In the eighth embodiment of the present disclosure, the reflective member P may be a prism, but alternatively may be a mirror.

At least one lens group among the first to fourth lens groups G1 to G4 may be moved to change a total focal length of the optical imaging system. As an example, the first lens group G1 and the third lens group G3 may be fixed and the second lens group G2 may be moved along an optical axis of the optical imaging system to change the total focal length of the optical imaging system may be changed. That is, as the second lens group G2 is moved away from an object side of the optical imaging system toward an image side of the optical imaging system, the total focal length of the optical imaging system may be changed from a wide-angle mode to a normal mode to a telephoto mode.

In addition, at least one lens group among the first to fourth lens groups G1 to G4 may be moved to correct a focal position according to a change in the total focal length of the optical imaging system. As an example, when the total focal length of the optical imaging system is changed from the wide-angle mode to the telephoto mode, the fourth lens group G4 may be moved along the optical axis to correct the focal position.

The characteristics of each lens (a radius of curvature, a thickness of a lens or a distance between lenses, a refractive index, and an Abbe number) are listed in Table 22 below.

TABLE 22

| Surface | | Radius of | Thickness or | Refractive | Abbe | Lens |
|---|---|---|---|---|---|---|
| No. | Component | Curvature | Distance | Index | Number | Group |
| Object | | | D0 | | | |
| S1 | Prism | Infinity | 3.55 | 1.5168 | 64.2 | |
| S2 | | Infinity | 3.55 | 1.5168 | 64.2 | |
| S3 | | Infinity | 0.5 | | | |
| S4 | First Lens | 17.562 | 0.45 | 1.95375 | 32.32 | First |
| S5 | Second | 11.005 | 2.3 | 1.618 | 63.4 | Lens |
| S6 | Lens | −104.45 | D1 | | | Group |
| S7 | Third | 23.967 | 0.55 | 1.535 | 55.73 | Second |
| S8 | Lens | 5.431 | 1.331 | | | Lens |
| S9 | Fourth | 17.603 | 0.3 | 1.535 | 55.73 | Group |
| S10 | Lens | 4.918 | 0.66 | | | |
| S11 | Fifth | 4.312 | 0.6 | 1.6355 | 23.89 | |
| S12 | Lens | 5.917 | D2 | | | |
| | Stop | Infinity | 0 | | | Third |
| S13 | Sixth | 3.995 | 0.89 | 1.535 | 55.73 | Lens |
| S14 | Lens | −41.591 | 0.1 | | | Group |
| S15 | Seventh | 5.988 | 0.69 | 1.6355 | 23.89 | |
| S16 | Lens | 3 | D3 | | | |
| S17 | Eighth | 5.648 | 1.03 | 1.535 | 55.73 | Fourth |
| S18 | Lens | −20.334 | 1.337 | | | Lens |
| S19 | Ninth | −16.928 | 0.4 | 1.535 | 55.73 | Group |
| S20 | Lens | 8.762 | 2.344 | | | |
| S21 | Tenth | −13.137 | 0.94 | 1.6355 | 23.89 | |
| S22 | Lens | −19.08 | D4 | | | |
| S23 | Filter | Infinity | 0.21 | 1.5168 | 64.2 | |
| S24 | | Infinity | D5 | | | |
| S25 | Imaging Plane | Infinity | | | | |

TABLE 23

| Object at Infinity | | | | Object at Near Focus Position | | | |
|---|---|---|---|---|---|---|---|
| | Wide-Angle | Normal | Telephoto | | Wide-Angle | Normal | Telephoto |
| Value | Mode | Mode | Mode | Value | Mode | Mode | Mode |
| D0 | Infinity | Infinity | Infinity | D0 | 600 | 600 | 600 |
| D1 | 2.2049 | 9.6613 | 15.1178 | D1 | 2.2049 | 9.6613 | 15.1178 |
| D2 | 13.7387 | 6.2823 | 0.8258 | D2 | 13.7387 | 6.2823 | 0.8258 |
| D3 | 6.992517 | 4.278296 | 3.900559 | D3 | 6.840726 | 3.660069 | 1.756575 |
| D4 | 3.153883 | 5.868104 | 6.245841 | D4 | 3.305674 | 6.486331 | 8.389825 |
| D5 | 0.1 | 0.1 | 0.1 | D5 | 0.1 | 0.1 | 0.1 |
| f | 8.4278 | 18.1478 | 33.6297 | MAG | 0.0136 | 0.0291 | 0.0563 |
| HFOV | 15.47 | 7.619 | 4.202 | HFOV | 15.423 | 7.466 | 3.874 |
| Fno | 3.492 | 3.851 | 3.868 | Fno | 3.511 | 3.963 | 4.295 |
| L | 47.922 | 47.922 | 47.922 | L | 47.922 | 47.922 | 47.922 |

In Table 23 above, DO may be an object distance, i.e., a distance on the optical axis between an object and a first surface of the reflective member P, D1 may be a distance on the optical axis between the second lens 802 and the third lens 803, D2 may be a distance on the optical axis between the fifth lens 805 and the stop, D3 may be a distance on the optical axis between the seventh lens 807 and the eighth lens 808, D4 may be a distance on the optical axis between the tenth lens 810 and the filter 811, and D5 may be a distance on the optical axis between the filter 811 and the imaging plane 812.

f may be a total focal length of the optical imaging system, MAG may be a magnification of the optical imaging system, HFOV may be one half of a field of view of the optical imaging system, Fno may be a F-number of the optical imaging system, and L may be a distance on the optical axis from a first surface of the reflective member P to the imaging plane 812.

The values in Table 23 above are listed for the wide-angle, normal, and telephoto modes for both an object at infinity and an object at a near focus position of the optical imaging system, i.e., a closest position of the object at which the optical imaging system can focus an image of the object.

A focal length fG1 of the first lens group G1 may be 33.5349 mm, a focal length fG2 of the second lens group G2 may be −8.8477 mm, a focal length fG3 of the third lens group G3 may be 13.9929 mm, and a focal length fG4 of the fourth lens group G4 may be 25.6853 mm.

A focal length of the first lens 801 may be −31.976 mm, a focal length of the second lens 802 may be 16.234 mm, a focal length of the third lens 803 may be −13.263 mm, a focal length of the fourth lens 804 may be −12.863 mm, a focal length of the fifth lens 805 may be 21.842 mm, a focal length of the sixth lens 806 may be 6.860 mm, a focal length of the seventh lens 807 may be −10.393 mm, a focal length of the eighth lens 808 may be 8.378 mm, a focal length of the ninth lens 809 may be −10.733 mm, and a focal length of the tenth lens 810 may be −70.713 mm.

Among the third to tenth lenses 803 to 810, the third lens 803 may have a largest effective radius.

An effective radius of the third lens 803 may be 3.5 mm, and a radius of the stop may be 2.35 mm.

An entrance pupil diameter EPDw of the optical imaging system in the wide-angle mode may be 2.415 mm, and an entrance pupil diameter EPDt of the optical imaging system in the telephoto mode may be 8.59 mm.

In the eighth embodiment of the present disclosure, the first lens group G1 may generally have a positive refractive power, the second lens group G2 may generally have a negative refractive power, the third lens group G3 may generally have a positive refractive power, and the fourth lens group G4 may generally have a positive refractive power.

The first lens 801 may have a negative refractive power, a first surface of the first lens 801 may be convex, and a second surface of the first lens 801 may be concave.

The second lens 802 may have a positive refractive power, first and second surfaces of the second lens 802 may be convex.

The first lens 801 and the second lens 802 may be bonded lenses bonded to each other.

The third lens 803 may have a negative refractive power, a first surface of the third lens 803 may be convex, and a second surface of the third lens 803 may be concave.

The fourth lens 804 may have a negative refractive power, a first surface of the fourth lens 804 may be convex, and a second surface of the fourth lens 804 may be concave.

The fifth lens 805 may have a positive refractive power, a first surface of the fifth lens 805 may be convex, and a second surface of the fifth lens 805 may be concave.

The sixth lens 806 may have a positive refractive power, and first and second surfaces of the sixth lens 806 may be convex. The stop may be disposed at the same position on the optical axis as the first surface of the sixth lens 806, i.e., an object-side surface of the sixth lens 806.

The seventh lens 807 may have a negative refractive power, a first surface of the seventh lens 807 may be convex, and a second surface of the seventh lens 807 may be concave.

The eighth lens 808 may have a positive refractive power, and first and second surfaces of the eighth lens 808 may be convex.

The ninth lens 809 may have a negative refractive power, and first and second surfaces of the ninth lens 809 may be concave.

The tenth lens 810 may have a negative refractive power, a first surface of the tenth lens 810 may be concave, and a second surface of the tenth lens 810 may be convex.

Surfaces of each of the third lens 803 to tenth lens 810 may have aspherical coefficients as listed in Table 24 below. For example, object-side surfaces and image-side surfaces of the remaining lenses, other than the first lens 801 and the second lens 802, may be aspherical surfaces.

TABLE 24

| Value | S7 | S8 | S9 | S10 | S11 | S12 | S13 | S14 |
|---|---|---|---|---|---|---|---|---|
| Conic Constant (K) | −15.901 | −3.945 | −80.000 | 0.744 | −1.075 | −7.761 | −0.365 | −73.710 |
| 4th-Order Coefficient (A) | 7.935E−04 | −2.152E−05 | −3.842E−03 | 1.138E−03 | −1.456E−03 | −1.822E−03 | −4.562E−05 | 1.660E−04 |
| 6th-Order Coefficient (B) | 5.056E−05 | 1.170E−04 | 3.842E−06 | −2.637E−04 | −3.667E−05 | −3.092E−05 | 1.964E−05 | −1.788E−05 |
| 8th-Order Coefficient (C) | −5.579E−06 | −9.994E−06 | 2.350E−06 | −3.469E−05 | −1.062E−05 | 9.107E−06 | −1.617E−05 | −1.655E−05 |
| 10th-Order Coefficient (D) | −2.797E−07 | −4.914E−07 | −2.325E−06 | −1.282E−06 | 4.081E−08 | −1.308E−06 | 4.268E−07 | 1.012E−06 |
| Value | S15 | S16 | S17 | S18 | S19 | S20 | S21 | S22 |
| Conic Constant (K) | −10.060 | −0.684 | −0.972 | −77.726 | 48.070 | −20.736 | 31.331 | −23.521 |
| 4th-Order Coefficient (A) | −1.146E−03 | −7.336E−03 | −2.859E−04 | 1.158E−03 | −5.388E−05 | −7.541E−03 | −1.559E−02 | −9.265E−03 |
| 6th-Order Coefficient (B) | −5.854E−05 | 9.528E−04 | −7.205E−05 | −6.057E−04 | 1.936E−03 | 2.949E−03 | −3.888E−04 | 2.714E−04 |
| 8th-Order Coefficient (C) | 3.477E−05 | −6.551E−05 | −1.471E−04 | −9.517E−05 | 5.097E−04 | 4.490E−04 | 5.154E−04 | 1.371E−04 |
| 10th-Order Coefficient (D) | −6.336E−07 | 7.432E−06 | −1.226E−06 | 2.284E−06 | −1.492E−04 | −1.231E−04 | −2.645E−05 | −6.692E−06 |

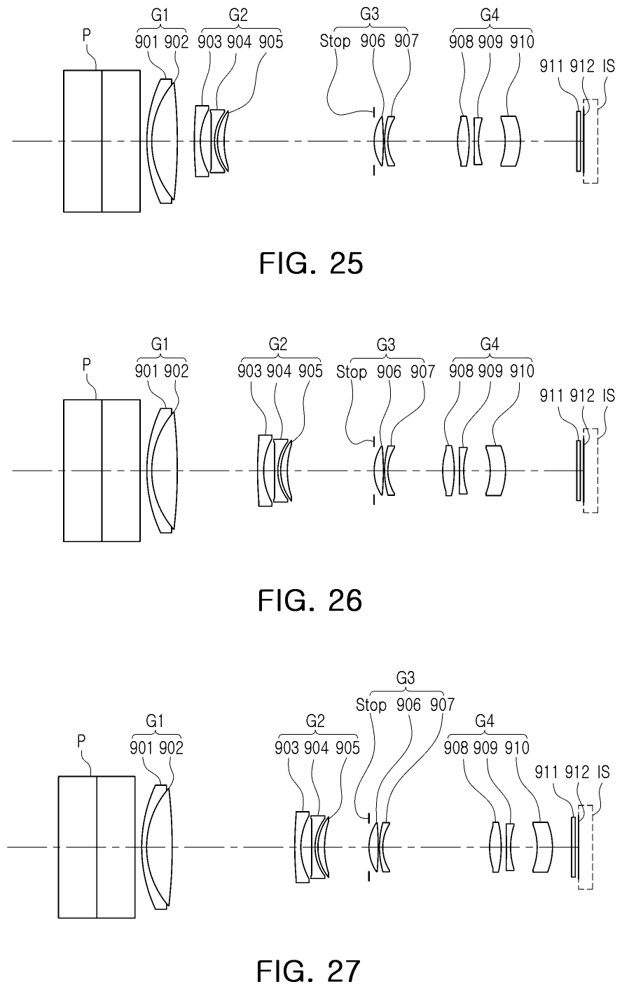

FIG. 25 is a diagram illustrating a wide-angle mode of an optical imaging system according to a ninth embodiment of the present disclosure. FIG. 26 is a diagram illustrating a normal mode of the optical imaging system of FIG. 25. FIG. 27 is a diagram illustrating a telephoto mode of the optical imaging system of FIG. 25.

The optical imaging system according to the ninth embodiment of the present disclosure will be described with reference to FIGS. 25 to 27.

The optical imaging system according to the ninth embodiment of the present disclosure may include a first lens group G1, a second lens group G2, a third lens group G3, and a fourth lens group G4. In addition, the optical imaging system may include a reflective member P disposed in front of the first lens group G1.

In sequence from an object side of the optical imaging system, the first lens group G1 may include a first lens 901 and a second lens 902, the second lens group G2 may include a third lens 903, a fourth lens 904, and a fifth lens 905, the third lens group G3 may include a stop, a sixth lens 906, and a seventh lens 907, and the fourth lens group G4 may include an eighth lens 908, a ninth lens 909, and a tenth lens 910.

In addition, the optical imaging system may further include a filter 911 and an image sensor IS.

The optical imaging system according to the ninth embodiment of the present disclosure may form a focal point on an imaging plane 912. The imaging plane 912 may refer to a surface on which a focal point is formed by the optical imaging system. As an example, the imaging plane 912 may refer to one surface of the image sensor IS receiving light.

In the ninth embodiment of the present disclosure, the reflective member P may be a prism, but alternatively may be a mirror.

At least one lens group among the first to fourth lens groups G1 to G4 may be moved to change a total focal length of the optical imaging system. As an example, the first lens group G1 and the third lens group G3 may be fixed and the second lens group G2 may be moved along an optical axis of the optical imaging system to change the total focal length of the optical imaging system may be changed. That is, as the second lens group G2 is moved away from an object side of the optical imaging system toward an image side of the optical imaging system, the total focal length of the optical imaging system may be changed from a wide-angle mode to a normal mode to a telephoto mode.

In addition, at least one lens group among the first to fourth lens groups G1 to G4 may be moved to correct a focal position according to a change in the total focal length of the optical imaging system. As an example, when the total focal length of the optical imaging system is changed from the wide-angle mode to the telephoto mode, the fourth lens group G4 may be moved along the optical axis to correct the focal position.

The characteristics of each lens (a radius of curvature, a thickness of a lens or a distance between lenses, a refractive index, and an Abbe number) are listed in Table 25 below.

TABLE 25

| Surface | | Radius of | Thickness or | Refractive | Abbe | Lens |
|---|---|---|---|---|---|---|
| No. | Component | Curvature | Distance | Index | Number | Group |
| Object | | | D0 | | | |
| S1 | Prism | Infinity | 3.55 | 1.5168 | 64.2 | |
| S2 | | Infinity | 3.55 | 1.5168 | 64.2 | |
| S3 | | Infinity | 0.5 | | | |
| S4 | First Lens | 13.398 | 0.45 | 1.95375 | 32.32 | First |
| S5 | Second Lens | 8.472 | 2.3 | 1.618 | 63.4 | Lens |
| S6 | | −48.736 | D1 | | | Group |
| S7 | Third Lens | 130.26 | 0.55 | 1.535 | 55.73 | Second |
| S8 | | 5.06 | 0.938 | | | Lens |
| S9 | Fourth Lens | 12.594 | 0.3 | 1.535 | 55.73 | Group |
| S10 | | 4.269 | 0.307 | | | |
| S11 | Fifth Lens | 3.795 | 0.6 | 1.6355 | 23.89 | |
| S12 | | 4.974 | D2 | | | |
| | Stop | Infinity | 0 | | | Third |
| S13 | Sixth Lens | 4.157 | 0.77 | 1.535 | 55.73 | Lens |
| S14 | | −33.509 | 0.163 | | | Group |
| S15 | Seventh Lens | 5.71 | 0.28 | 1.6355 | 23.89 | |
| S16 | | 3.255 | D3 | | | |
| S17 | Eighth Lens | 5.757 | 1.03 | 1.535 | 55.73 | Fourth |
| S18 | | −18.901 | 0.518 | | | Lens |
| S19 | Ninth Lens | −16.719 | 0.4 | 1.535 | 55.73 | Group |
| S20 | | 8.8 | 2.435 | | | |
| S21 | Tenth Lens | −12.808 | 1.3 | 1.6355 | 23.89 | |
| S22 | | −14.474 | D4 | | | |
| S23 | Filter | Infinity | 0.21 | 1.5168 | 64.2 | |
| S24 | | Infinity | D5 | | | |
| S25 | Imaging Plane | Infinity | | | | |

TABLE 26

| Object at Infinity | | | | Object at Near Focus Position | | | |
|---|---|---|---|---|---|---|---|
| | Wide-Angle | Normal | Telephoto | | Wide-Angle | Normal | Telephoto |
| Value | Mode | Mode | Mode | Value | Mode | Mode | Mode |
| D0 | Infinity | Infinity | Infinity | D0 | 600 | 600 | 600 |
| D1 | 1.6215 | 7.4825 | 11.296 | D1 | 1.6215 | 7.4825 | 11.296 |
| D2 | 13.887 | 8.026 | 4.2125 | D2 | 13.887 | 8.026 | 4.2125 |
| D3 | 6.683677 | 5.30228 | 10.30903 | D3 | 6.519875 | 4.58538 | 7.408187 |
| D4 | 5.423823 | 6.80522 | 1.79847 | D4 | 5.587625 | 7.523962 | 4.699313 |
| D5 | 0.1 | 0.1 | 0.1 | D5 | 0.1 | 0.1 | 0.1 |
| f | 8.3932 | 18.5073 | 33.8555 | MAG | 0.0136 | 0.0294 | 0.0518 |
| HFOV | 16.483 | 7.41 | 3.943 | HFOV | 16.453 | 7.32 | 3.884 |
| Fno | 3.687 | 3.808 | 3.428 | Fno | 3.698 | 3.885 | 3.578 |
| L | 47.867 | 47.867 | 47.867 | L | 47.867 | 47.867 | 47.867 |

In Table 26 above, DO may be an object distance, i.e., a distance on the optical axis between an object and a first surface of the reflective member P, D1 may be a distance on the optical axis between the second lens 902 and the third lens 903, D2 may be a distance on the optical axis between the fifth lens 905 and the stop, D3 may be a distance on the optical axis between the seventh lens 907 and the eighth lens 908, D4 may be a distance on the optical axis between the tenth lens 910 and the filter 911, and D5 may be a distance on the optical axis between the filter 911 and the imaging plane 912.

f may be a total focal length of the optical imaging system, MAG may be a magnification of the optical imaging system, HFOV may be one half of a field of view of the optical imaging system, Fno may be a F-number of the optical imaging system, and L may be a distance on the optical axis from a first surface of the reflective member P to the imaging plane 912.

The values in Table 26 above are listed for the wide-angle, normal, and telephoto modes for both an object at infinity and an object at a near focus position of the optical imaging system, i.e., a closest position of the object at which the optical imaging system can focus an image of the object.

A focal length fG1 of the first lens group G1 may be 22.6771 mm, a focal length fG2 of the second lens group G2 may be −6.7956 mm, a focal length fG3 of the third lens group G3 may be 13.2855 mm, and a focal length fG4 of the fourth lens group G4 may be 28.3578 mm.

A focal length of the first lens 901 may be −25.288 mm, a focal length of the second lens 902 may be 11.861 mm, a focal length of the third lens 903 may be −9.855 mm, a focal length of the fourth lens 904 may be −12.225 mm, a focal length of the fifth lens 905 may be 21.034 mm, a focal length of the sixth lens 906 may be 6.962 mm, a focal length of the seventh lens 907 may be −12.465 mm, a focal length of the eighth lens 908 may be 8.370 mm, a focal length of the ninth lens 909 may be −10.718 mm, and a focal length of the tenth lens 910 may be −251.289 mm.

Among the third to tenth lenses 903 to 910, the third lens 903 may have a largest effective radius.

An effective radius of the third lens 903 may be 3.6 mm, and a radius of the stop may be 2.35 mm.

An entrance pupil diameter EPDw of the optical imaging system in the wide-angle mode may be 2.281 mm, and an entrance pupil diameter EPDt of the optical imaging system in the telephoto mode may be 9.85 mm.

In the ninth embodiment of the present disclosure, the first lens group G1 may generally have a positive refractive power, the second lens group G2 may generally have a negative refractive power, the third lens group G3 may generally have a positive refractive power, and the fourth lens group G4 may generally have a positive refractive power.

The first lens 901 may have a negative refractive power, a first surface of the first lens 901 may be convex, and a second surface of the first lens 901 may be concave.

The second lens 902 may have a positive refractive power, first and second surfaces of the second lens 902 may be convex.

The first lens 901 and the second lens 902 may be bonded lenses bonded to each other.

The third lens 903 may have a negative refractive power, a first surface of the third lens 903 may be convex, and a second surface of the third lens 903 may be concave.

The fourth lens 904 may have a negative refractive power, a first surface of the fourth lens 904 may be convex, and a second surface of the fourth lens 904 may be concave.

The fifth lens 905 may have a positive refractive power, a first surface of the fifth lens 905 may be convex, and a second surface of the fifth lens 905 may be concave.

The sixth lens 906 may have a positive refractive power, and first and second surfaces of the sixth lens 906 may be convex. The stop may be disposed at the same position on the optical axis as the first surface of the sixth lens 906, i.e., an object-side of the sixth lens 906.

The seventh lens 907 may have a negative refractive power, a first surface of the seventh lens 907 may be convex, and a second surface of the seventh lens 907 may be concave.

The eighth lens 908 may have a positive refractive power, and first and second surfaces of the eighth lens 908 may be convex.

The ninth lens 909 may have a negative refractive power, and first and second surfaces of the ninth lens 909 may be concave.

The tenth lens 910 may have a negative refractive power, a first surface of the tenth lens 910 may be concave, and a second surface of the tenth lens 910 may be convex.

Surfaces of each of the third lens 903 to tenth lens 910 may have aspherical coefficients as listed in Table 27 below. For example, object-side surfaces and image-side surfaces of the remaining lenses, other than the first lens 901 and the second lens 902, may be aspherical surfaces.

TABLE 27

| Value | S7 | S8 | S9 | S10 | S11 | S12 | S13 | S14 |
|---|---|---|---|---|---|---|---|---|
| Conic Constant (K) | −74.092 | −2.735 | −79.697 | 0.764 | −0.949 | −8.724 | −0.367 | −64.172 |
| 4th-Order Coefficient (A) | 4.625E−04 | 3.488E−04 | −3.951E−03 | 1.415E−03 | −1.220E−03 | −2.064E−03 | −6.972E−05 | 1.298E−04 |
| 6th-Order Coefficient (B) | 4.587E−05 | 8.937E−05 | 2.951E−05 | −2.709E−04 | −1.467E−05 | −4.296E−05 | 2.891E−05 | −2.815E−05 |
| 8th-Order Coefficient (C) | −5.880E−06 | −1.342E−05 | 5.532E−06 | −3.690E−05 | −9.360E−06 | 9.973E−06 | −1.543E−05 | −1.713E−05 |
| 10th-Order Coefficient (D) | −3.050E−07 | −7.242E−07 | −2.125E−06 | −1.476E−06 | 2.577E−08 | −1.108E−06 | 4.101E−07 | 1.031E−06 |
| Value | S15 | S16 | S17 | S18 | S19 | S20 | S21 | S22 |
| Conic Constant (K) | −10.567 | −0.672 | −0.902 | −69.401 | 49.659 | −18.867 | 32.627 | −5.064 |
| 4th-Order Coefficient (A) | −1.134E−03 | −7.255E−03 | −2.398E−04 | 1.159E−03 | −2.753E−05 | −7.492E−03 | −1.470E−02 | −9.487E−03 |
| 6th-Order Coefficient (B) | −4.869E−05 | 9.402E−04 | −8.265E−05 | −6.069E−04 | 1.953E−03 | 2.929E−03 | −2.777E−04 | 3.119E−04 |
| 8th-Order Coefficient (C) | 3.496E−05 | −6.678E−05 | −1.467E−04 | −9.691E−05 | 5.101E−04 | 4.491E−04 | 5.483E−04 | 1.283E−04 |
| 10th-Order Coefficient (D) | −7.972E−07 | 7.335E−06 | −8.856E−07 | 1.897E−06 | −1.509E−04 | −1.189E−04 | −2.108E−05 | −9.768E−06 |

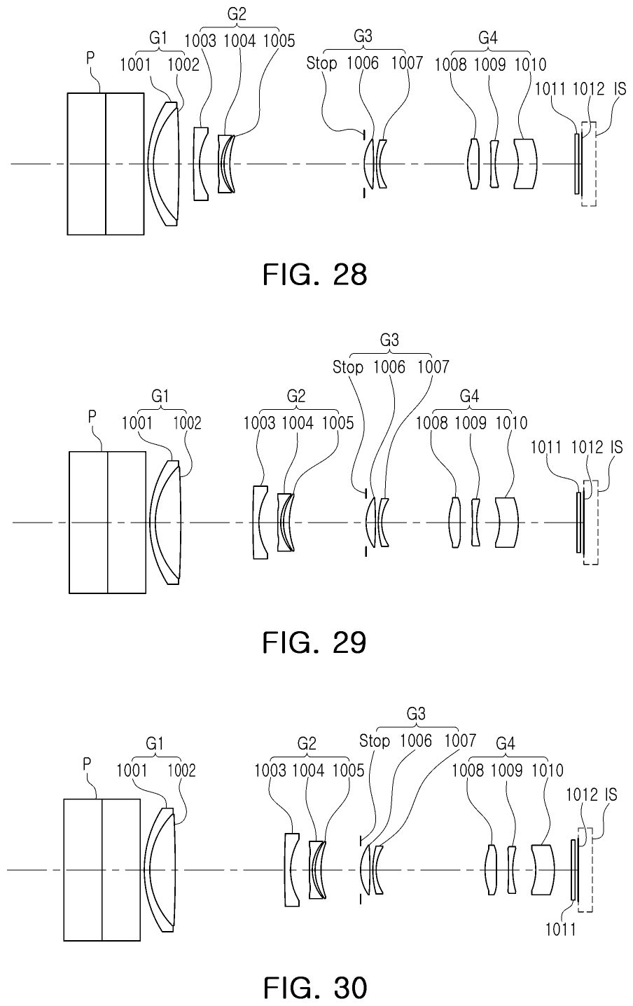

FIG. 28 is a diagram illustrating a wide-angle mode of an optical imaging system according to a tenth embodiment of the present disclosure. FIG. 29 is a diagram illustrating a normal mode of the optical imaging system of FIG. 28. FIG. 30 is a diagram illustrating a telephoto mode of the optical imaging system of FIG. 28.

The optical imaging system according to the tenth embodiment of the present disclosure will be described with reference to FIGS. 28 to 30.

The optical imaging system according to the tenth embodiment of the present disclosure may include a first lens group G1, a second lens group G2, a third lens group G3, and a fourth lens group G4. In addition, the optical imaging system may include a reflective member P disposed in front of the first lens group G1.

In sequence from an object side of the optical imaging system, the first lens group G1 may include a first lens 1001 and a second lens 1002, the second lens group G2 may include a third lens 1003, a fourth lens 1004, and a fifth lens 1005, the third lens group G3 may include a stop, a sixth lens 1006, and a seventh lens 1007, and the fourth lens group G4 may include an eighth lens 1008, a ninth lens 1009, and a tenth lens 1010.

In addition, the optical imaging system may further include a filter 1011 and an image sensor IS.

The optical imaging system according to the tenth embodiment of the present disclosure may form a focal point on an imaging plane 1012. The imaging plane 1012 may refer to a surface on which a focal point is formed by the optical imaging system. As an example, the imaging plane 1012 may refer to one surface of the image sensor IS receiving light.

In the tenth embodiment of the present disclosure, the reflective member P may be a prism, but alternatively may be a mirror.

At least one lens group among the first to fourth lens groups G1 to G4 may be moved to change a total focal length of the optical imaging system. As an example, the first lens group G1 and the third lens group G3 may be fixed and the second lens group G2 may be moved along an optical axis of the optical imaging system to change the total focal length of the optical imaging system may be changed. That is, as the second lens group G2 is moved away from an object side of the optical imaging system toward an image side of the optical imaging system, the total focal length of the optical imaging system may be changed from a wide-angle mode to a normal mode to a telephoto mode.

In addition, at least one lens group among the first to fourth lens groups G1 to G4 may be moved to correct a focal position according to a change in the total focal length of the optical imaging system. As an example, when the total focal length of the optical imaging system is changed from the wide-angle mode to the telephoto mode, the fourth lens group G4 may be moved along the optical axis to correct the focal position.

The characteristics of each lens (a radius of curvature, a thickness of a lens or a distance between lenses, a refractive index, and an Abbe number) are listed in Table 28 below.

TABLE 28

| Surface | | Radius of | Thickness or | Refractive | Abbe | Lens |
|---|---|---|---|---|---|---|
| No. | Component | Curvature | Distance | Index | Number | Group |
| Object | | | D0 | | | |
| S1 | Prism | Infinity | 3.55 | 1.5168 | 64.2 | |
| S2 | | Infinity | 3.55 | 1.5168 | 64.2 | |
| S3 | | Infinity | 0.5 | | | |
| S4 | First Lens | 10.771 | 0.45 | 1.95375 | 32.32 | First |
| S5 | Second | 7.274 | 2.3 | 1.618 | 63.4 | Lens |
| S6 | Lens | −196.761 | D1 | | | Group |
| S7 | Third | −191.405 | 0.55 | 1.535 | 55.73 | Second |
| S8 | Lens | 5.106 | 1.715 | | | Lens |
| S9 | Fourth | 11.346 | 0.3 | 1.535 | 55.73 | Group |
| S10 | Lens | 4.126 | 0.213 | | | |
| S11 | Fifth | 3.701 | 0.6 | 1.6355 | 23.89 | |
| S12 | Lens | 4.571 | D2 | | | |
| | Stop | Infinity | 0 | | | Third |
| S13 | Sixth | 4.116 | 0.77 | 1.535 | 55.73 | Lens |
| S14 | Lens | −40.169 | 0.328 | | | Group |
| S15 | Seventh | 5.673 | 0.28 | 1.6355 | 23.89 | |
| S16 | Lens | 3.271 | D3 | | | |
| S17 | Eighth | 5.75 | 1.05 | 1.535 | 55.73 | Fourth |
| S18 | Lens | −19.096 | 1.099 | | | Lens |
| S19 | Ninth | −16.896 | 0.4 | 1.535 | 55.73 | Group |
| S20 | Lens | 8.733 | 2.145 | | | |
| S21 | Tenth | −12.903 | 1.65 | 1.6355 | 23.89 | |
| S22 | Lens | −16.924 | D4 | | | |
| S23 | Filter | Infinity | 0.21 | 1.5168 | 64.2 | |
| S24 | | Infinity | D5 | | | |
| S25 | Imaging Plane | Infinity | | | | |

TABLE 29

| Object at Infinity | | | | Object at Near Focus Position | | | |
|---|---|---|---|---|---|---|---|
| | Wide-Angle | Normal | Telephoto | | Wide-Angle | Normal | Telephoto |
| Value | Mode | Mode | Mode | Value | Mode | Mode | Mode |
| D0 | Infinity | Infinity | Infinity | D0 | 600 | 600 | 600 |
| D1 | 1.4861 | 6.8738 | 10.2733 | D1 | 1.4861 | 6.8738 | 10.2733 |
| D2 | 12.5606 | 7.1729 | 3.7734 | D2 | 12.5606 | 7.1729 | 3.7734 |
| D3 | 8.167984 | 6.294524 | 10.15432 | D3 | 8.012297 | 5.592368 | 7.658936 |
| D4 | 3.934316 | 5.807776 | 1.947982 | D4 | 4.090003 | 6.509932 | 4.443364 |
| D5 | 0.1 | 0.1 | 0.1 | D5 | 0.1 | 0.1 | 0.1 |
| f | 8.4311 | 18.9455 | 33.6487 | MAG | 0.0137 | 0.0302 | 0.0526 |
| HFOV | 16.607 | 7.518 | 4.158 | HFOV | 16.569 | 7.403 | 4.017 |
| Fno | 3.716 | 3.9 | 3.52 | Fno | 3.729 | 3.989 | 3.701 |
| L | 47.909 | 47.909 | 47.909 | L | 47.909 | 47.909 | 47.909 |

In Table 29 above, DO may be an object distance, i.e., a distance on the optical axis between an object and a first surface of the reflective member P, D1 may be a distance on the optical axis between the second lens 1002 and the third lens 1003, D2 may be a distance on the optical axis between the fifth lens 1005 and the stop, D3 may be a distance on the optical axis between the seventh lens 1007 and the eighth lens 1008, D4 may be a distance on the optical axis between the tenth lens 1010 and the filter 1011, and D5 may be a distance on the optical axis between the filter 1011 and the imaging plane 1012.

f may be a total focal length of the optical imaging system, MAG may be a magnification of the optical imaging system, HFOV may be one half of a field of view of the optical imaging system, Fno may be a F-number of the optical imaging system, and L may be a distance on the optical axis from a first surface of the reflective member P to the imaging plane 1012.

The values in Table 29 above are listed for the wide-angle, normal, and telephoto modes for both an object at infinity and an object at a near focus position of the optical imaging system, i.e., a closest position of the object at which the optical imaging system can focus an image of the object.

A focal length fG1 of the first lens group G1 may be 21.6379 mm, a focal length fG2 of the second lens group G2 may be −6.0243 mm, a focal length fG3 of the third lens group G3 may be 12.9161 mm, and a focal length fG4 of the fourth lens group G4 may be 26.6022 mm.

A focal length of the first lens 1001 may be −25.065 mm, a focal length of the second lens 1002 may be 11.400 mm, a focal length of the third lens 1003 may be −9.287 mm, a focal length of the fourth lens 1004 may be −12.297 mm, a focal length of the fifth lens 1005 may be 24.131 mm, a focal length of the sixth lens 1006 may be 7.021 mm, a focal length of the seventh lens 1007 may be −12.733 mm, a focal length of the eighth lens 1008 may be 8.384 mm, a focal length of the ninth lens 1009 may be −10.703 mm, and a focal length of the tenth lens 1010 may be −97.734 mm.

Among the third to tenth lenses 1003 to 1010, the third lens 1003 may have a largest effective radius.

An effective radius of the third lens 1003 may be 3.6 mm, and a radius of the stop may be 2.35 mm.

An entrance pupil diameter EPDw of the optical imaging system in the wide-angle mode may be 2.260 mm, and an entrance pupil diameter EPDt of the optical imaging system in the telephoto mode may be 9.55 mm.

In the tenth embodiment of the present disclosure, the first lens group G1 may generally have a positive refractive power, the second lens group G2 may generally have a negative refractive power, the third lens group G3 may generally have a positive refractive power, and the fourth lens group G4 may generally have a positive refractive power.

The first lens 1001 may have a negative refractive power, a first surface of the first lens 1001 may be convex, and a second surface of the first lens 1001 may be concave.

The second lens 1002 may have a positive refractive power, first and second surfaces of the second lens 1002 may be convex.

The first lens 1001 and the second lens 1002 may be bonded lenses bonded to each other.

The third lens 1003 may have a negative refractive power, first and second surfaces of the third lens 1003 may be concave.

The fourth lens 1004 may have a negative refractive power, a first surface of the fourth lens 1004 may be convex, and a second surface of the fourth lens 1004 may be concave.

The fifth lens 1005 may have a positive refractive power, a first surface of the fifth lens 1005 may be convex, and a second surface of the fifth lens 1005 may be concave.

The sixth lens 1006 may have a positive refractive power, and first and second surfaces of the sixth lens 1006 may be convex. The stop may be disposed at the same position on the optical axis as the first surface of the sixth lens 1006, i.e., an object-side of the sixth lens 1006.

The seventh lens 1007 may have a negative refractive power, a first surface of the seventh lens 1007 may be convex, and a second surface of the seventh lens 1007 may be concave.

The eighth lens 1008 may have a positive refractive power, and first and second surfaces of the eighth lens 1008 may be convex.

The ninth lens 1009 may have a negative refractive power, and first and second surfaces of the ninth lens 1009 may be concave.

The tenth lens 1010 may have a negative refractive power, a first surface of the tenth lens 1010 may be concave, and a second surface of the tenth lens 1010 may be convex.

Surfaces of each of the third lens 1003 to tenth lens 1010 may have aspherical coefficients as listed in Table 30 below. For example, object-side surfaces and image-side surfaces of the remaining lenses, other than the first lens 1001 and the second lens 1002, may be aspherical surfaces.

TABLE 30

| Value | S7 | S8 | S9 | S10 | S11 | S12 | S13 | S14 |
|---|---|---|---|---|---|---|---|---|
| Conic Constant (K) | 80.000 | −2.677 | −79.422 | 0.771 | −0.904 | −8.928 | −0.381 | −71.865 |
| 4th-Order Coefficient (A) | 4.479E−04 | 3.750E−04 | −4.005E−03 | 1.502E−03 | −1.113E−03 | −2.105E−03 | −1.039E−04 | 1.415E−04 |
| 6th-Order Coefficient (B) | 4.538E−05 | 8.950E−05 | 1.841E−05 | −2.637E−04 | −1.442E−06 | −5.070E−05 | 2.600E−05 | −2.998E−05 |
| 8th-Order Coefficient (C) | −5.945E−06 | −1.210E−05 | 4.650E−06 | −3.651E−05 | −7.691E−06 | 8.762E−06 | −1.556E−05 | −1.771E−05 |
| 10th-Order Coefficient (D) | −3.166E−07 | −5.598E−07 | −2.219E−06 | −1.543E−06 | 2.281E−07 | −1.241E−06 | 4.251E−07 | 9.075E−07 |
| Value | S15 | S16 | S17 | S18 | S19 | S20 | S21 | S22 |
| Conic Constant (K) | −10.610 | −0.676 | −0.827 | −63.221 | 49.187 | −22.960 | 32.468 | −17.454 |
| 4th-Order Coefficient (A) | −1.138E−03 | −7.279E−03 | −1.874E−04 | 1.175E−03 | 1.469E−04 | −7.667E−03 | −1.466E−02 | −9.024E−03 |
| 6th-Order Coefficient (B) | −4.869E−05 | 9.379E−04 | −8.515E−05 | −5.958E−04 | 1.963E−03 | 2.928E−03 | −2.644E−04 | 3.454E−04 |
| 8th-Order Coefficient (C) | 3.469E−05 | −6.593E−05 | −1.479E−04 | −9.453E−05 | 5.102E−04 | 4.535E−04 | 5.579E−04 | 1.245E−04 |
| 10th-Order Coefficient (D) | −9.193E−07 | 7.872E−06 | −1.159E−06 | 2.243E−06 | −1.512E−04 | −1.171E−04 | −1.945E−05 | −1.105E−05 |

Table 31 below lists the focal lengths fG1, fG2, fG3, and fG4 of the first to fourth lens groups G1, G2, G3, and G4 in the first to tenth embodiments.

TABLE 31

| Embodiment | fG1 | fG2 | fG3 | fG4 |
|---|---|---|---|---|
| 1 | 30.5342 | −9.5675 | 14.9498 | 20.8760 |
| 2 | 35.7392 | −9.7724 | 14.5797 | 19.3917 |
| 3 | 15.1816 | −9.6820 | 13.2062 | 10.2967 |
| 4 | 35.9056 | −9.5692 | 16.8011 | 16.4336 |
| 5 | 34.9006 | −9.7502 | 16.0521 | 17.9994 |
| 6 | 36.7491 | −9.8578 | 15.2439 | 20.5837 |
| 7 | 33.9465 | −9.0888 | 13.9672 | 26.0426 |
| 8 | 33.5349 | −8.8477 | 13.9929 | 25.6853 |
| 9 | 22.6771 | −6.7956 | 13.2855 | 28.3578 |
| 10 | 21.6379 | −6.0243 | 12.9161 | 26.6022 |

Table 32 below lists the focal lengths f1 to f10 of the first to tenth lenses in the first to tenth embodiments.

TABLE 32

| Embodiment | f1 | f2 | f3 | f4 | f5 | f6 | f7 | f8 | f9 | f10 |
|---|---|---|---|---|---|---|---|---|---|---|
| 1 | −29.878 | 14.918 | −96.836 | −7.308 | 20.886 | 6.659 | −8.170 | 8.837 | −11.104 | 46.192 |
| 2 | −36.671 | 17.863 | −18.071 | −10.625 | 17.469 | 6.850 | −9.341 | 8.292 | −11.077 | 83.429 |
| 3 | −23.131 | 8.977 | −9.276 | 96.008 | 6.740 | −7.145 | 10.297 | — | — | — |
| 4 | −37.972 | 17.542 | −21.269 | −9.744 | 18.472 | 6.836 | −9.091 | 8.255 | −11.082 | 66.174 |
| 5 | −40.877 | 18.701 | −22.921 | −9.438 | 17.903 | 6.840 | −9.500 | 8.240 | −11.082 | 102.155 |
| 6 | −37.201 | 18.248 | −16.968 | −11.174 | 17.797 | 6.801 | −9.287 | 8.309 | −11.109 | −7572.053 |
| 7 | −30.829 | 16.034 | −15.293 | −11.835 | 20.388 | 6.805 | −10.005 | 8.342 | −10.996 | −80.302 |
| 8 | −31.976 | 16.234 | −13.263 | −12.863 | 21.842 | 6.860 | −10.393 | 8.378 | −10.733 | −70.713 |
| 9 | −25.288 | 11.861 | −9.855 | −12.225 | 21.034 | 6.962 | −12.465 | 8.370 | −10.718 | −251.289 |
| 10 | −25.065 | 11.400 | −9.287 | −12.297 | 24.131 | 7.021 | −12.733 | 8.384 | −10.703 | −97.734 |

Table 33 below lists the values of n1, n2, Dmax, SD, EPDt, EPDw, fG1, LG3, dG2, BFLw (infinity), BFLt (infinity), BFLw (near), BFLt (near), L, (n1+n2)/2, Dmax/SD, EPDt/EPDw, fG1/L, LG3/L, dG2/L, BFLw/BFLt (infinity), BFLw/BFLt (near) in the first to tenth embodiments. BFLw (infinity), BFLt (infinity), and BFLw/BFLt (infinity) are values for an object at infinity, and BFLw (near), BFLt (near), and BFLw/BFLt (near) are values for an object at a near focus position of the optical imaging system, i.e., a closest position of the object at which the optical imaging system can focus an image of the object.

TABLE 33

| Value | Emb. 1 | Emb. 2 | Emb. 3 | Emb. 4 | Emb. 5 |
|---|---|---|---|---|---|
| n1 | 1.94782 | 1.95375 | 1.80518 | 1.95375 | 1.95375 |
| n2 | 1.71402 | 1.618 | 1.72916 | 1.618 | 1.618 |
| Dmax | 3.56 | 3.44 | 2.73 | 3.25 | 3.25 |
| SD | 2.54 | 2.35 | 2.2 | 2.35 | 2.35 |
| EPDt | 11.2 | 8.93 | 6.14 | 9.21 | 9.43 |
| EPDw | 3.268 | 2.398 | 4.702 | 2.488 | 2.470 |
| fG1 | 30.5342 | 35.7392 | 15.1816 | 35.9056 | 34.9006 |
| LG3 | 28.424660 | 29.308000 | 13.036220 | 29.124680 | 28.88785 |
| dG2 | 12.702440 | 14.687000 | 2.253530 | 14.297520 | 14.59971 |
| BFLw (infinity) | 9.536423 | 6.091743 | 5.263741 | 6.084868 | 6.017528 |
| BFLt (infinity) | 4.827961 | 8.767370 | 3.169340 | 8.416236 | 7.704191 |
| BFLw (near) | 9.802705 | 6.237200 | 5.636559 | 6.209281 | 6.149123 |
| BFLt (near) | 8.844760 | 10.793580 | 3.948435 | 10.332470 | 9.667858 |
| L | 48.400 | 47.885 | 25.000 | 48.185 | 47.850 |
| (n1 + n2)/2 | 1.83 | 1.79 | 1.77 | 1.79 | 1.79 |
| Dmax/SD | 1.402 | 1.464 | 1.241 | 1.383 | 1.383 |
| EPDt/EPDw | 3.43 | 3.72 | 1.31 | 3.70 | 3.82 |
| fG1/L | 0.631 | 0.746 | 0.607 | 0.745 | 0.729 |
| LG3/L | 0.587 | 0.612 | 0.521 | 0.604 | 0.604 |
| dG2/L | 0.262 | 0.307 | 0.090 | 0.297 | 0.305 |
| BFLw/BFLt (infinity) | 1.975 | 0.695 | 1.661 | 0.723 | 0.781 |
| BFLw/BFLt (near) | 1.108 | 0.578 | 1.428 | 0.601 | 0.636 |
| Value | Emb. 6 | Emb. 7 | Emb. 8 | Emb. 9 | Emb. 10 |
| n1 | 1.95375 | 1.95375 | 1.95375 | 1.95375 | 1.95375 |
| n2 | 1.618 | 1.618 | 1.618 | 1.618 | 1.618 |
| Dmax | 3.25 | 3.25 | 3.5 | 3.6 | 3.6 |
| SD | 2.35 | 2.35 | 2.35 | 2.35 | 2.35 |
| EPDt | 8.81 | 8.65 | 8.59 | 9.85 | 9.55 |
| EPDw | 2.458 | 2.403 | 2.415 | 2.281 | 2.260 |
| fG1 | 36.7491 | 33.9465 | 33.5349 | 22.6771 | 21.6379 |
| LG3 | 30.3835 | 30.623100 | 29.734600 | 28.553500 | 27.774700 |
| dG2 | 14.4677 | 13.314000 | 12.912900 | 9.674500 | 8.787200 |
| BFLw (infinity) | 5.5933 | 5.061873 | 3.463883 | 5.733823 | 4.244316 |
| BFLt (infinity) | 8.3126 | 7.835614 | 6.555841 | 2.108470 | 2.257982 |
| BFLw (near) | 5.7326 | 5.215544 | 3.615674 | 5.897625 | 4.400003 |
| BFLt (near) | 10.3385 | 9.998520 | 8.699825 | 5.009313 | 4.753364 |
| L | 47.9272 | 47.856 | 47.922 | 47.867 | 47.909 |
| (n1 + n2)/2 | 1.79 | 1.79 | 1.79 | 1.79 | 1.79 |
| Dmax/SD | 1.383 | 1.383 | 1.489 | 1.532 | 1.532 |
| EPDt/EPDw | 3.58 | 3.60 | 3.56 | 4.32 | 4.23 |
| fG1/L | 0.767 | 0.709 | 0.700 | 0.474 | 0.452 |
| LG3/L | 0.634 | 0.640 | 0.620 | 0.597 | 0.580 |
| dG2/L | 0.302 | 0.278 | 0.269 | 0.202 | 0.183 |
| BFLw/BFLt (infinity) | 0.673 | 0.646 | 0.528 | 2.719 | 1.880 |
| BFLw/BFLt (near) | 0.554 | 0.522 | 0.416 | 1.177 | 0.926 |

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group, a second lens group, a third lens group, and a fourth lens group sequentially disposed in ascending numerical order along an optical axis of the optical imaging system away from an object side of the optical imaging system toward an imaging plane of the optical imaging system, at least one lens group among the first to fourth lens groups being configured to be movable along the optical axis; and
a reflective member disposed on an object side of the first lens group and comprising a reflective surface configured to change an optical path of the optical imaging system,
wherein the first lens group has a positive refractive power, and
0.45≤fG1/L≤0.8 is satisfied, where fG1 is a focal length of the first lens group, and L is a distance on the optical axis from an object-side surface of the reflective member to the imaging plane.

2. The optical imaging system of claim 1, wherein the first lens group comprises a first lens and a second lens sequentially disposed in ascending numerical order along the optical axis from an object side of the first lens group toward an image side of the first lens group,
one of the first lens and the second lens has a positive focal length and an Abbe number of 50 or more, and
another one of the first lens and the second lens has a negative focal length and an Abbe number of 30 or less.

3. The optical imaging system of claim 2, wherein (n1+n2)/2>1.7 is satisfied, wherein n1 is a refractive index of the first lens and n2 is a refractive index of the second lens.

4. The optical imaging system of claim 3, wherein an image-side surface of the first lens and an object-side surface of the second lens are bonded to each other, and
the first lens and the second lens are each made of a respective glass material.

5. The optical imaging system of claim 1, wherein the second lens group has a negative refractive power, comprises at least two lenses, and is configured to move along the optical axis away from the object side of the optical imaging system toward the image side of the optical imaging system to narrow a field of view of the optical imaging system.

6. The optical imaging system of claim 5, wherein 0.4≤LG3/L≤0.7 is satisfied, where LG3 is a distance on the optical axis from the object-side surface of the reflective member to an object-side surface of a frontmost lens of the third lens group.

7. The optical imaging system of claim 5, wherein 0.08≤dG2/L≤0.7 is satisfied, where dG2 is a distance along the optical axis that the second lens group moves from a wide-angle mode of the optical imaging system to a telephoto mode of the optical imaging system.

8. The optical imaging system of claim 5, wherein a frontmost lens of the second lens group has a largest effective radius among all lenses in the second to fourth lens groups.

9. The optical imaging system of claim 5, wherein the first lens group and the third lens group are fixedly disposed, and the fourth lens group is configured to move along the optical axis to correct a focal position of the optical imaging system as the second lens group is moved along the optical axis.

10. The optical imaging system of claim 9, wherein 0.4≤BFLw/BFLt≤2.8 is satisfied, where BFLw is a distance on the optical axis from an image-side surface of a last lens of the fourth lens group to the imaging plane in a wide-angle mode of the optical imaging system, and BFLt is a distance on the optical axis from the image-side surface of the last lens of the fourth lens group to the imaging plane in a telephoto mode of the optical imaging system.

11. The optical imaging system of claim 9, wherein the third lens group and the fourth lens group each have a positive refractive power.

12. The optical imaging system of claim 5, wherein the third lens group comprises a stop and a plurality of lenses sequentially disposed along the optical axis away from an object side of the third lens group toward an image side of the third lens group, and a lens disposed closest to the stop among the plurality of lenses of the third lens group has a positive refractive power.

13. The optical imaging system of claim 12, wherein 1.2≤Dmax/SD≤1.55 is satisfied, where Dmax is an effective radius of a lens having a largest effective radius among all lenses in the second to fourth lens groups, and SD is a radius of the stop.

14. The optical imaging system of claim 12, wherein the third lens group comprises two lenses sequentially disposed along the optical axis away from the object side of the third lens group toward the image side of the third lens group,
one of the two lenses of the third lens group has a positive focal length and an Abbe number greater than 50, and
another one of the two lenses of the third lens group has a negative focal length and an Abbe number less than 30.

15. The optical imaging system of claim 1, wherein the fourth lens group comprises at least one lens having an Abbe number greater than 50.

16. The optical imaging system of claim 1, wherein 1.2≤EPDt/EPDw≤4.4 is satisfied, where EPDw is an entrance pupil diameter of the optical imaging system in a wide-angle mode of the optical imaging system, and EPDt is an entrance pupil diameter of the optical imaging system in a telephoto mode of the optical imaging system.

17. An optical imaging system comprising:
a first lens group, a second lens group, a third lens group, and a fourth lens group sequentially disposed in ascending numerical order along an optical axis of the optical imaging system away from an object side of the optical imaging system toward an imaging plane of the optical imaging system, at least one lens group among the first to fourth lens groups being configured to be movable along the optical axis; and
a reflective member disposed on an object side of the first lens group and comprising a reflective surface configured to change an optical path of the optical imaging system,
wherein the first lens group has a positive refractive power, and
0.4≤LG3/L≤0.7 is satisfied, where LG3 is a distance on the optical axis from an object-side surface of the reflective member to an object-side surface of the third lens group.

18. The optical imaging system of claim 17, wherein the first lens group comprises two lenses,
the second lens group has a negative refractive power and comprises two or three lenses,
the third lens group has a positive refractive power and comprises a stop and two lenses, and
the fourth lens group has a positive refractive power and comprises one or two lenses.

19. The optical imaging system of claim 17, wherein the second lens group is configured to be movable along the optical axis to change a focal length of the optical imaging system between a wide-angle mode and a telephoto mode, and
0.4≤BFLw/BFLt≤2.8 is satisfied, where BFLw is a distance from an image-side surface of a last lens of the fourth lens group to the imaging plane in the wide-angle mode, and BFLt is a distance from the image-side surface of the last lens of the fourth lens group to the imaging plane in the telephoto mode.

20. The optical imaging system of claim 17, wherein the second lens group is configured to be movable along the optical axis to change a focal length of the optical imaging system between a wide-angle mode and a telephoto mode, and
1.2≤EPDt/EPDw≤4.4 is satisfied, where EPDw is an entrance pupil diameter of the optical imaging system in the wide-angle mode, and EPDt is an entrance pupil diameter of the optical imaging system in the telephoto mode.

21. An optical imaging system comprising:
a first lens group, a second lens group, a third lens group, and a fourth lens group sequentially disposed in ascending numerical order along an optical axis of the optical imaging system away from an object side of the optical imaging system toward an imaging plane of the optical imaging system, the second lens group being configured to be movable along the optical axis to change a focal length of the optical imaging system between a wide-angle mode and a telephoto mode; and
a reflective member disposed on an object side of the first lens group and comprising a reflective surface configured to change an optical path of the optical imaging system,
wherein the first lens group has a positive refractive power, and
0.08≤dG2/L≤0.7 is satisfied, where dG2 is a distance along the optical axis that the second lens group moves between the wide-angle mode and the telephoto mode.

22. The optical imaging system of claim 21, wherein the first lens group comprises two lenses,
the second lens group has a negative refractive power and comprises two or three lenses,
the third lens group has a positive refractive power and comprises a stop and two lenses, and
the fourth lens group has a positive refractive power and comprises one or two lenses.

23. The optical imaging system of claim 21, wherein 0.4≤BFLw/BFLt≤2.8 is satisfied, where BFLw is a distance from an image-side surface of a last lens of the fourth lens group to the imaging plane in the wide-angle mode, and BFLt is a distance from the image-side surface of the last lens of the fourth lens group to the imaging plane in the telephoto mode.

24. The optical imaging system of claim 21, wherein 1.2≤EPDt/EPDw≤4.4 is satisfied, where EPDw is an entrance pupil diameter of the optical imaging system in the wide-angle mode, and EPDt is an entrance pupil diameter of the optical imaging system in the telephoto mode.
